(19) United States
(12) Patent Application Publication
(10) Pub. No.: US 2025/0151091 A1
(43) Pub. Date: May 8, 2025

(54) TRANSMISSION OF PHYSICAL SIDELINK FEEDBACK CHANNELS

(71) Applicant: Samsung Electronics Co., Ltd., Suwon-si (KR)

(72) Inventors: Carmela Cozzo, San Diego, CA (US); Emad Nader Farag, Flanders, NJ (US); Hongbo Si, Allen, TX (US)

(21) Appl. No.: 18/919,252

(22) Filed: Oct. 17, 2024

Related U.S. Application Data
(60) Provisional application No. 63/547,272, filed on Nov. 3, 2023.
(60) Provisional application No. 63/547,476, filed on Nov. 6, 2023.

(51) Int. Cl. H04W 72/25; H04W 74/0808

(52) U.S. Cl. CPC H04W 72/25; H04W 74/0808

(57) ABSTRACT

Apparatuses and methods for transmission of physical sidelink feedback channels (PSFCHs). A method performed by a user equipment (UE) in a wireless communication system includes receiving first information related to a sidelink operation on multiple sidelink carriers and receiving, via a sidelink control information (SCI) format, second information related to a first carrier from the multiple sidelink carriers for transmission of a PSFCH. The PSFCH includes hybrid automatic repeat request acknowledgement (HARQ-ACK) information corresponding to reception of a physical sidelink shared channel (PSSCH). Reception of a physical sidelink control channel (PSCCH) associated with the PSSCH is on a second carrier. The method further includes determining a resource for transmission of the PSFCH on the first carrier from a sidelink resource pool of PSFCH resources associated with the first carrier and transmitting the PSFCH on the first carrier using the resource.

### CROSS-REFERENCE TO RELATED AND CLAIM OF PRIORITY

The present application claims priority under 35 U.S.C. § 119 (e) to U.S. Provisional Patent Application No. 63/547,272 filed on Nov. 3, 2023, and U.S. Provisional Patent Application No. 63/547,476 filed on Nov. 6, 2023, which are hereby incorporated by reference in their entirety.

### TECHNICAL FIELD

The present disclosure relates generally to wireless communication systems and, more specifically, the present disclosure is related to apparatuses and methods for transmission of physical sidelink feedback channels (PSFCHs).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to transmission of PSFCHs.

In one embodiment, a user equipment (UE) in a wireless communication system is provided. The UE includes a transceiver configured to receive first information related to a sidelink operation on multiple sidelink carriers and receive, via a sidelink control information (SCI) format, second information related to a first carrier from the multiple sidelink carriers for transmission of a PSFCH. The PSFCH includes hybrid automatic repeat request acknowledgement (HARQ-ACK) information corresponding to reception of a physical sidelink shared channel (PSSCH). Reception of a physical sidelink control channel (PSCCH) associated with the PSSCH is on a second carrier. The UE further includes a processor operably coupled to the transceiver. The processor is configured to determine a resource for transmission of the PSFCH on the first carrier from a sidelink resource pool of PSFCH resources associated with the first carrier. The transceiver is further configured to transmit the PSFCH on the first carrier using the resource.

In another embodiment, a method performed by a UE in a wireless communication system is provided. The method includes receiving first information related to a sidelink operation on multiple sidelink carriers and receiving, via a SCI format, second information related to a first carrier from the multiple sidelink carriers for transmission of a PSFCH. The PSFCH includes HARQ-ACK information corresponding to reception of a PSSCH. Reception of a PSCCH associated with the PSSCH is on a second carrier. The method further includes determining a resource for transmission of the PSFCH on the first carrier from a sidelink resource pool of PSFCH resources associated with the first carrier and transmitting the PSFCH on the first carrier using the resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate examples of a wireless transmit and receive paths according to embodiments of the present disclosure;

FIG. 5 illustrates a flowchart of an example process for a layer-2 link establishment for unicast mode of vehicle to everything (V2X) communication over protocol layer convergence for 5G new radio (PC5) reference point according to embodiments of the present disclosure;

FIG. 6 illustrates a diagram of an example time domain resource determination for PSFCH according to embodiments of the present disclosure;

FIGS. 7A and 7B illustrate examples of a sidelink transmission and reception resources according to embodiments of the present disclosure;

FIG. 8 illustrates a flowchart of an example UE procedure for determining a slot for PSFCH transmission according to embodiments of the present disclosure;

FIG. 9 illustrates a diagram of example slot formats for sidelink operation according to embodiments of the present disclosure;

FIG. 10 illustrates a flowchart of an example UE procedure for receiving physical sidelink shared channels (PSSCHs) and transmitting corresponding PSFCHs according to embodiments of the present disclosure; and

FIGS. 11A and 11B illustrate diagrams of example PSFCH transmissions with repetitions according to embodiments of the present disclosure.

### DETAILED DESCRIPTION

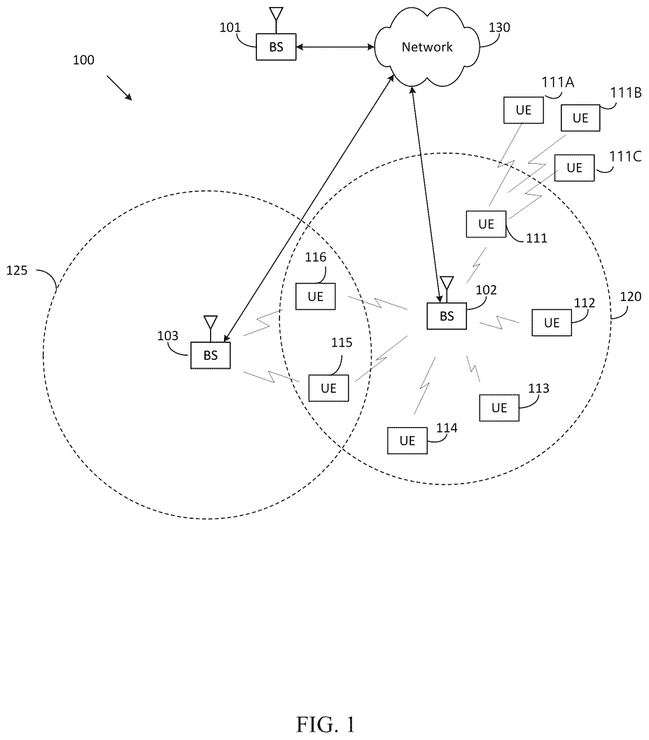

FIGS. 1-11B, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v18.0.0, “NR; Physical channels and modulation;” [2] 3GPP TS 38.212 v18.0.0, “NR; Multiplexing and Channel coding;” [3] 3GPP TS 38.213 v18.0.0, “NR; Physical Layer Procedures for Control;” [4] 3GPP TS 38.214 v18.0.0, “NR; Physical Layer Procedures for Data;” [5] 3GPP TS 38.321 v17.6.0, “NR; Medium Access Control (MAC) protocol specification;” [6] 3GPP TS 38.331 v17.6.0, “NR; Radio Resource Control (RRC) Protocol Specification;” and [7] 3GPP TS 36.213 v17.4.0, “Evolved Universal Terrestrial Radio Access (E-UTRA); Physical layer procedures.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing transmission of PSFCHs. In certain embodiments, one or more of the BSs 101-103 include circuitry, programing, or a combination thereof for supporting transmission of PSFCHs.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to common fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

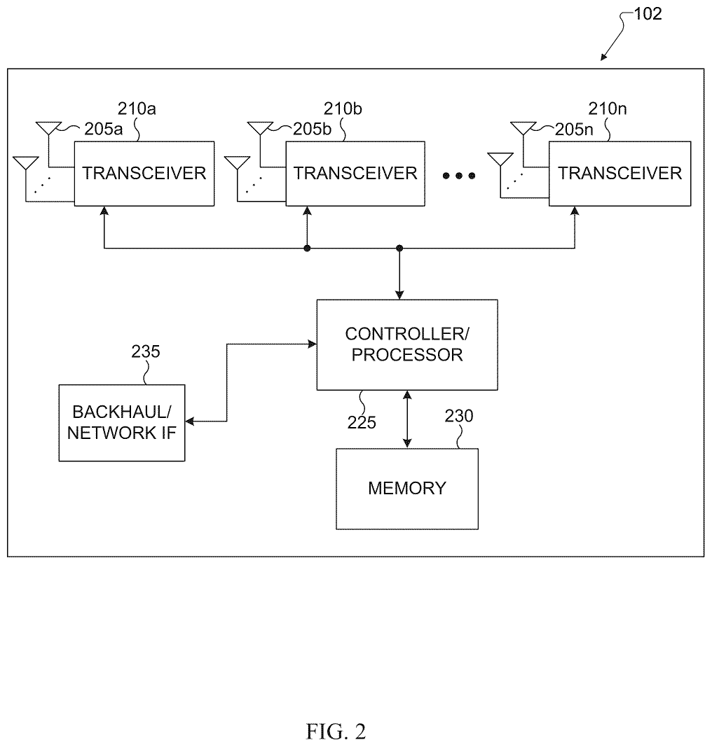

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting transmission of PSFCHs. Any of a wide variety of other functions could be supported in the gNB 102 by the controller/processor 225.

The controller/processor 225 is also capable of executing programs and other processes resident in the memory 230, such as supporting transmission of PSFCHs. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

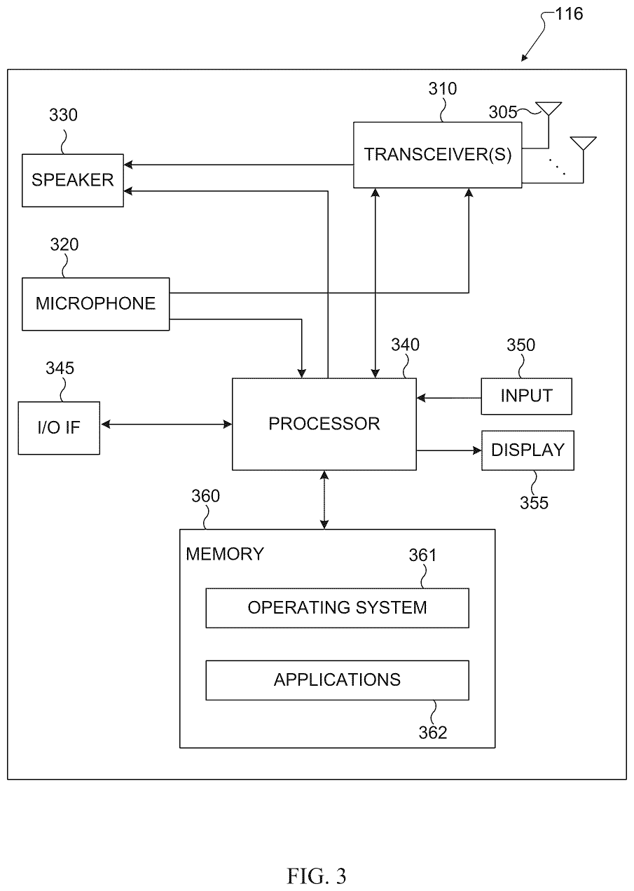

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for transmission of PSFCHs as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

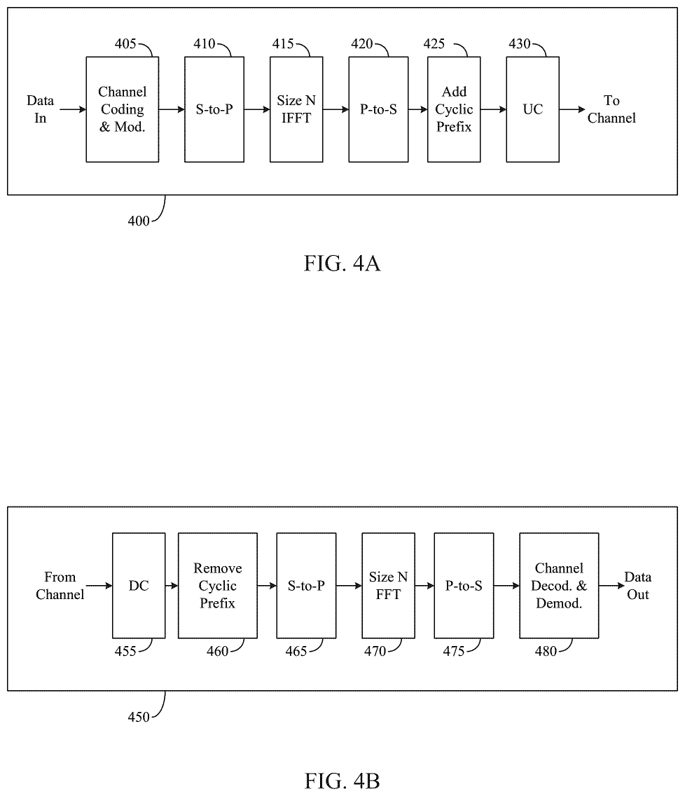

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It may also be understood that the receive path 450 can be implemented in a first UE and that the transmit path 400 can be implemented in a second UE to support SL communications. In some embodiments, the transmit path 400 is configured to support transmission of PSFCHs as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

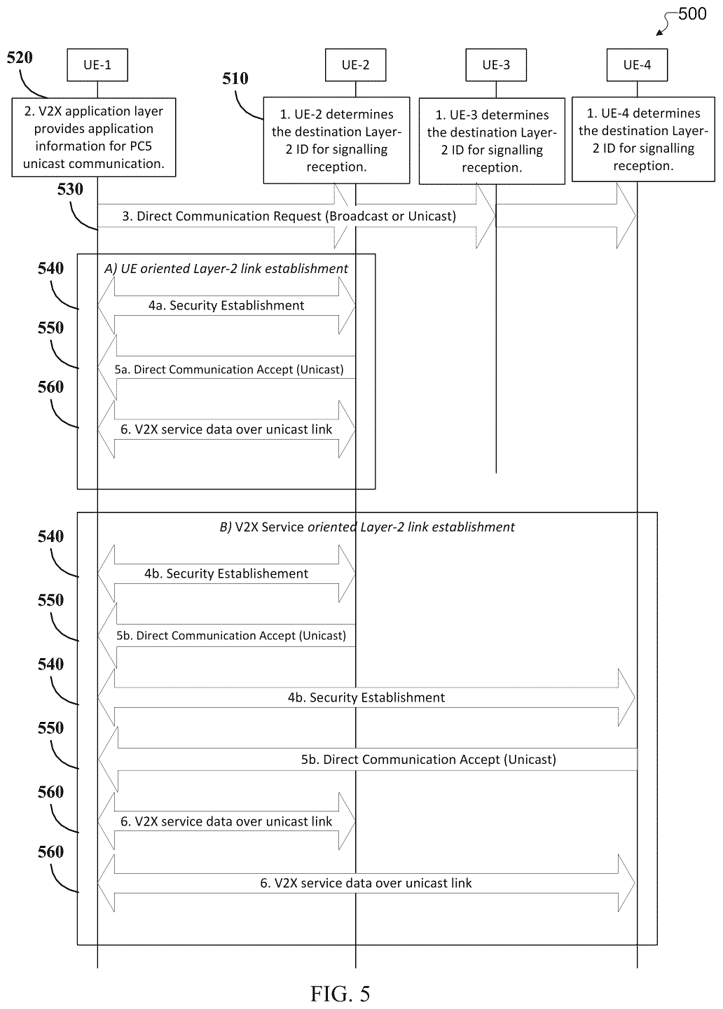

FIG. 5 illustrates a flowchart of an example process 500 for a layer-2 link establishment for unicast mode of V2X communication over PC5 reference point according to embodiments of the present disclosure. For example, process 500 can be performed by multiple of the UEs 111-116 of FIG. 1 to perform SL communications. This example is for illustration only and other embodiments can be used without departing from the scope of the present disclosure.

Process 500 begins in step 510, the UE(s) determine the destination Layer-2 ID for signaling reception of PC5 unicast link establishment. This is determined as specified in clause 5.6.1.4 of TS 23.287. The destination Layer-2 ID is configured with the UE(s) as specified in clause 5.1.2.1 of TS 23.287. In step 520, the V2X application layer in UE-1 provides application information for PC5 unicast communicating. In step 530, UE-1 sends a Direct Communication Request (DCR) to initiate the unicast layer-2 link establishment procedure and sends the DCR message via PC5 broadcast or unicast using the source Layer-2 ID and destination Layer-2 ID. In step 540, the target UE, or the UEs that are interested in using the announced V2X service type(s) over a PC5 unicast link with UE-1, responds which establishes the security with UE-1. In step 550, the target UE(s) that has successfully established security with UE-1 sends a direct communication accept message to UE-1. In step 560, V2X service data is transmitted over the established unicast link.

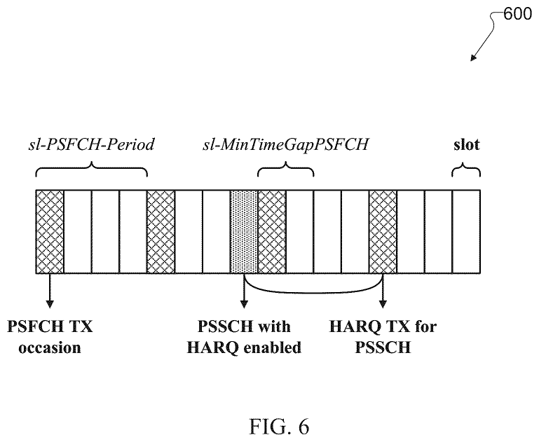

With reference to FIG. 5 (FIG. 6.3.3.1-1 of TS 23.287) the Layer-2 link establishment procedure for unicast mode of V2X communication over PC5 reference point is shown.

When a UE is configured for sidelink operation on multiple carriers, the UE can be configured with one or more resource pools for each of the multiple carriers, and transmissions and receptions of PSSCH, physical sidelink control channel (PSCCH), and PSFCH in each carrier are confined within and associated with the one or more resource pools configured for the corresponding carrier, with parameters (pre-)configured by higher layers for each carrier (e.g. SL-PSSCH-Config, SL-PSCCH-Config, and SL-PSFCH-Config, respectively). The UE performs the procedures for single carrier, as described in 3GPP TS 38.214 [REF4] v18.0.0, Clauses 8 and 8.1 for transmitting the PSSCH, in 3GPP TS 38.213 [REF3] v18.0.0, Clauses 16.4 for transmitting the PSCCH, and in 3GPP TS 38.213 [REF3] v18.0.0, Clauses 16.3.0 for transmitting the PSFCH, in each of the multiple carriers using corresponding configured resource pools.

A UE configured for sidelink operation on multiple carriers would be configured with higher layer parameter SL-PSFCH-Config for each of the multiple carriers. Fields of SL-PSFCH-Config determine PSFCH transmission occasion resources from a resource pool, can be set to same or different values for the multiple carriers, and the setting of the parameters can be done independently in each carrier or relatively among carriers. If a procedure for transmitting PSFCH would ensure that resources for PSFCHs are aligned in time over the multiple carriers, the procedure may be subject to different or additional rules and configurations depending on whether a sidelink control information (SCI) format scheduling a PSSCH reception that indicates to transmit a PSFCH with hybrid automatic repeat request acknowledgement (HARQ-ACK) information in response to the PSSCH reception is transmitted on a same or different carrier of the carrier where the PSFCH is transmitted.

Thus, embodiments of the present disclosure recognize that there is a need to identify rules and configurations to determine resources for PSFCH transmission occasions that are time aligned on the multiple carriers.

When a UE is configured for sidelink operation on multiple carriers, an SCI format scheduling a PSSCH reception on a first carrier can indicate to transmit a PSFCH with HARQ-ACK information in response to the PSSCH reception on a second carrier. Throughout this disclosure, this case is also referred as cross-carrier scheduling of a PSFCH transmission, and the first carrier is referred as the scheduling carrier. A slot, or generally PSFCH resources, on the second carrier identified for the PSFCH transmission in response to the PSSCH reception on the first carrier, may or may not be available for the PSFCH transmission. An unavailability of the slot may depend on the slot being identified for transmission of more than one PSFCH.

Thus, there is a need to determine resources for a PSFCH transmission on a carrier when the PSFCH transmission is in response to a PSSCH reception on another carrier.

There is another need to determine resources for a PSFCH transmission in a slot on a carrier when the PSFCH transmission is in response to a PSSCH reception on another carrier, and the slot is not available for the PSFCH transmission.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 KHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (negative acknowledgment (NACK) value) transport block receptions in respective PSSCHs, and physical SL Broadcast channel (PSBCH) conveying system information to assist in SL synchronization. SL signals include demodulation reference signals (DM-RS) that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A transport block (TB) is carried in a PSSCH. The SCI indicates the resources used by the PSSCH that carries the associated TB, as well as further information required for decoding the TB. A PSCCH is sent with a PSSCH. The SCI is transmitted in two stages: 1st-stage SCI is carried on the PSCCH and 2nd-stage SCI is carried on the corresponding PSSCH, and such flexible SCI design can support unicast, groupcast, and broadcast transmissions. Splitting the SCI in two stages (1st-stage SCI and 2nd-stage SCI) allows other UEs which are not RX UEs of a transmission to decode only the 1st-stage SCI for channel sensing purposes, i.e., for determining the resources reserved by other transmissions. On the other hand, the 2nd-stage SCI provides additional control information which is required for the RX UE(s) of a transmission.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a downlink control information (DCI) format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where UEs have no communication with any gNB, or with partial network coverage, where only some UEs are within the communication range of a gNB.

In case of groupcast PSCCH/PSSCH transmission, a network can configure a UE one of two options for reporting of HARQ-ACK information by the UE:
HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.
HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

Transmission and reception of PSSCH, PSCCH, and PSFCH are confined within and associated with a resource pool, with parameters (pre-)configured by higher layers (e.g. SL-PSSCH-Config, SL-PSCCH-Config, and SL-PSFCH-Config, respectively).

A UE transmits the PSSCH in consecutive symbols within a slot of the resource pool, and PSSCH resource allocation starts from the second symbol configured for sidelink, e.g. startSLsymbol+1, and the first symbol configured for sidelink is duplicated from the second configured for sidelink, for automatic gain control (AGC) purpose. The UE does not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool, by a higher layer parameter sl-TimeResourcePSCCH, starting from the second symbol configured for sidelink, e.g. startSLsymbol+1; and further provided a number of RBs in the resource pool, by a higher layer parameter sl-FreqResourcePSCCH, starting from the lowest RB of the lowest sub-channel of the associated PSSCH.

FIG. 6 illustrates a diagram of an example time domain resource determination 600 for PSFCH according to embodiments of the present disclosure. For example, time domain resource determination 600 for PSFCH can be utilized by any of the UEs 111-116 of FIG. 1, such as the UE 111. This example is for illustration only and other embodiments can be used without departing from the scope of the present disclosure.

A UE can be provided a number of slots by a higher layer parameter sl-PSFCH-Period in the resource pool for a period of PSFCH transmission occasion resources, and a slot in the resource pool is determined as containing a PSFCH transmission occasion, if the relative slot index within the resource pool is an integer multiple of the period of PSFCH transmission occasion, and with at least a number of slots provided by a higher layer parameter sl-MinTimeGapPSFCH after the last slot of the PSSCH reception. PSFCH is transmitted in two contiguous symbols in a slot, wherein the second symbol is with index startSLsymbols+lengthSLsymbols−2, and the two symbols are repeated. With reference to FIG. 6, an illustration of the time domain resource determination for PSFCH is shown.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′MAX-1}^{SL}} and can be configured, for example, at least using a bitmap. Where, T′_{MAX} is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

The slots of a SL resource pool are determined as follows:
1. Let set of slots that may belong to a resource be denoted by {t′₀^{SL}, t′₁^{SL}, t′₂^{SL}, . . . , t′_{T′MAX-1}^{SL}}, where 0≤tᵢ^{SL}<10240×2^{μ}, and 0≤Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=8 for a 120 kHz sub-carrier spacing. The slot index is relative to slot #0 of system frame number (SFN) #0 of the serving cell, or downlink frame number (DFN) #0. The set of slots includes slots except:
   a. N_{S-SSB} slots that are configured for SL synchronization signal/physical broadcast channel (SS/PBCH) Block (S-SSB).
   b. N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   C. N_{reserved} reserved slots. Reserved slots are determined such that the slots in the set {t′₀^{SL}, t′₁^{SL}, t′₂^{SL}, . . . , t′_{T′MAX-1}^{SL}} is a multiple of the bitmap length (L_{bitmap}), where the bitmap (b₀, b₁, . . . , b_{L}_{_{bitmax}}−1) is configured by higher layers. The reserved slots are determined as follows:
      i. Let {l₀, l₁, . . . , l₂_{^{μ}}_{×10240-N}_{_{S-SSB}}_{-N}_{_{nonSL}}₋₁} be the set of slots in range 0 . . . 2^{u}×10240−1, excluding S-SSB slots and non-SL slots. The slots are arranged in ascending order of the slot index.
      ii. The number of reserved slots is given by: N_{reserved}=(2^{μ}×10240−N_{S-SSB}−N_{nonSL}) mod L_{bitmap}.
      iii. The reserved slots lᵣ are given by: r=└m·(2^{u}×10240−N_{S-SSB}−N_{nonSL})/N_{reserved}┘, where m=0, 1, . . . , N_{reserved}−1.
      iv. Tₘₐₓ is given by: Tₘₐₓ=2^{μ}×10240-N_{S-SSB}−N_{nonSL}−N_{reserved}.
2. The slots are arranged in ascending order of slot index.
3. The set of slots belonging to the SL resource pool, {t′₀^{SL}, t′₁^{SL}, t′₂^{SL}, . . . , t′_{T′MAX-1}^{SL}}, are determined as follows:
   a. Each resource pool has a corresponding bitmap (b₀, b₁, . . . , b_{L}_{_{bitmap}}−1) of length L_{bitmap}.
   b. A slot tₖ^{SL} belongs to the SL resource pool if b_{k mod L}_{_{bitmap}}=1
   c. The remaining slots are indexed successively staring from 0, 1, . . . . T′_{MAX}−1. Where, T′MAX is the number of remaining slots in the set.

Slots can be numbered (indexed) as physical slots or logical slots, wherein physical slots include slots numbered sequential, while logical slots include only slots that can be allocated to sidelink resource pool as described herein numbered sequentially. The conversion from a physical duration, Pᵣₛᵥₚ, in milli-second to logical slots, P′ᵣₛᵥₚ, is given by P′ᵣₛᵥₚ=┌T′max/10240 ms×Pᵣₛᵥₚ┐ (see section 8.1.7 of 38.214 [4]).

For a PSCCH transmission with a SCI format 1-A, a UE can be provided a number of symbols in a resource pool, by a higher layer parameter sl-TimeResourcePSCCH, starting from a second symbol that is available for SL transmissions in a slot, and a number of PRBs in the resource pool, by a higher layer parameter sl-FreqResourcePSCCH, starting from the lowest PRB of the lowest sub-channel of the associated PSSCH. A UE that transmits a PSCCH with SCI format 1-A using sidelink resource allocation mode 2 or mode 1 sets the values of the frequency resource assignment field and the time resource assignment field as described in 3GPP TS 38.213 [REF3] Clause 16.4.

A UE can be indicated by an SCI format scheduling a PSSCH reception to transmit a PSFCH with HARQ-ACK information in response to the PSSCH reception. The UE provides HARQ-ACK information that includes ACK or NACK, or only NACK. The UE can be provided a number of slots in a resource pool for a period of PSFCH transmission occasion resources by a higher layer parameter sl-PSFCH-Period. If the number is zero, PSFCH transmissions from the UE in the resource pool are disabled.

A UE expects that a slot t′ₖ^{SL} (0≤k<T′ₘₐₓ) has a PSFCH transmission occasion resource if k mod N_{PSSCH}^{PSFCH}=0, where t′ₖ^{SL} is a logical slot and T′ₘₐₓ is a number of slots that belong to the resource pool within 10240 msec, as previously described. N_{PSSCH}^{PSFCH} is provided by the higher layer parameter sl-PSFCH-Period.

A UE may be indicated by higher layers to not transmit a PSFCH that includes HARQ-ACK information in response to a PSSCH reception.

If a UE receives a PSSCH in a resource pool and the HARQ feedback enabled/disabled indicator field in an associated SCI format 2-A/2-B/2-C has value 1, the UE provides the HARQ-ACK information in a PSFCH transmission in the resource pool. The UE transmits the PSFCH in a first slot that includes PSFCH resources and is at least a number of slots, provided by higher layer parameter sl-MinTimeGapPSFCH, of the resource pool after a last slot of the PSSCH reception.

A UE can be provided by higher layer parameter sl-PSFCH-RB-Set a set of M_{PRB, set}^{PSFCH} PRBs in a resource pool for PSFCH transmission with HARQ-ACK information in a PRB of the resource pool. A UE can be provided by higher layer parameter sl-RB-SetPSFCH a set of M_{PRB, set}^{PSFCH} PRBs in a resource pool for PSFCH transmission with conflict information in a PRB of the resource pool. Different PRBs are (pre)configured for conflict information and HARQ-ACK information. For a number of N_{subch} sub-channels for the resource pool, provided by higher layer parameter sl-NumSubchannel, and a number of PSSCH slots associated with a PSFCH slot that is less than or equal to N_{PSSCH}^{PSFCH}, the UE allocates the [(i+j·N_{PSSCH}^{PSFCH})·M_{sub, slot}^{PSFCH}, (i+1+j·N_{PSSCH}^{PSFCH})·M_{subch, slot}^{PSFCH}−1] PRBs from the M_{PRB, set}^{PSFCH} PRBs to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSFCH}, 0≤j<N_{subch}, and the allocation starts in an ascending order of i and continues in an ascending order of i. M_{PRB, set}^{PSFCH} is a multiple of N_{subch}·N_{PSSCH}^{PSFCH}.

A UE determines a number of PSFCH resources available for multiplexing HARQ-ACK or conflict information in a PSFCH transmission as R_{PRB, CS}^{PSFCH}=N_{type}^{PSFCH}·M_{subch, slot}^{PSFCH}·N_{CS}^{PSFCH} where N_{CS}^{PSFCH} is a number of cyclic shift pairs for the resource pool provided by higher layer parameter sl-NumMuxCS-Pair and, based on an indication by higher layer parameter sl-PSFCH-Candidate Resource Type,
N_{type}^{PSFCH}=1 and the M_{subch, slot}^{PSFCH} PRBs are associated with the starting sub-channel of the corresponding PSSCH if sl-PSFCH-Candidate Resource Type is configured as startSubCH, and
N_{type}^{PSFCH} N_{subch}^{PSSCH} subch and the N_{subch}^{PSSCH}·M_{subch, slot}^{PSFCH} PRBs are associated with the N_{PSSCH}^{PSFCH} sub-channels of the corresponding PSSCH, if sl-PSFCH-Candidate Resource Type is configured as allocSubCH.

For conflict information, the corresponding PSSCH is determined based on sl-PSFCH-Occasion.

The PSFCH resources are first indexed according to an ascending order of the PRB index, from the N_{type}^{PSFCH}·M_{subch, slot}^{PSFCH} PRBs, and then according to an ascending order of the cyclic shift pair index from the N_{CS}^{PSFCH} cyclic shift pairs.

A UE determines an index of a PSFCH resource, for a PSFCH transmission with HARQ-ACK information in response to a PSSCH reception or with conflict information, corresponding to a reserved resource as (P_{ID}+M_{ID})mod R_{PRB, CS}^{PSFCH} where P_{ID} is a physical layer source ID provided by SCI format 2-A/2-B/2-C scheduling the PSSCH reception, or by SCI format 2-A/2-B/2-C with corresponding SCI format 1-A reserving the resource from another UE to be provided with the conflict information. For HARQ-ACK information, M_{ID} is the identity of the UE receiving the PSSCH as indicated by higher layers if the UE detects a SCI format 2-A with Cast type indicator field value of “01”; otherwise, M_{ID} is zero. For conflict information, M_{ID} is zero.

For LTE SL, a UE (e.g., the UE 111) can operate with sidelink carrier aggregation (SL CA) for some modes of resource allocation (modes 3 and 4). When operating with CA, a given (sidelink) MAC protocol data unit (PDU) is transmitted, and if necessary re-transmitted, on a single sidelink carrier, and multiple MAC PDUs can be transmitted in parallel on different carriers. This provides a throughput gain in a similar way as for Uu CA. It is also feasible that the UE allowed to transmit and receive on multiple sidelink carriers (pre)configured by the network (e.g., the network 130) can select specific sidelink one or more carriers among them for transmission.

SL CA for resource allocation mode 3 using a dynamic grant is similar to the CA operation on the Uu interface that includes a carrier indication field (CIF) in the DCI from the eNB. This indicates which among the up to 8 configured sidelink carriers the allocation in the DCI applies to.

SL CA for resource allocation mode 4 uses a sensing procedure to select resources independently on each involved carrier. The same carrier is used for MAC PDUs of the same SL process at least until the process triggers resource re-selection. Procedures to avoid unexpected UE behavior when the demands of CA become high allow a UE to drop a transmission which uses an excessive amount of resources or transmit chains, or to reject and re-select resources for which it cannot meet the RF requirements under CA.

For synchronization in LTE SL CA operation, a SyncRef UE uses a single synchronization reference for aggregated carriers, and may transmit SLSS/PSBCH on one or multiple carriers according to a capability. A receiving UE uses the same synchronization reference (not necessarily a SyncRef UE) for its aggregated carriers, and it uses the highest priority synchronization reference present among the available synchronization carriers.

For NR SL, a UE can be configured for sidelink operation on multiple carriers and transmit sidelink synchronization signals and physical sidelink broadcast channel block (S-SS/PSBCH blocks on multiple carriers with a power for each S-SS/PSBCH block transmission derived as in 3GPP TS 38.213 [REF3] v18.0.0, “NR; Physical Layer Procedures for Control.”, Clause 16.2.0. If transmitted S-SS/PSBCH blocks would overlap in time on respective carriers and a total power for the transmissions of the S-SS/PSBCH blocks would exceed PCMAX, the UE reduces a power for one or more of the S-SS/PSBCH blocks transmissions so that a resulting total power would not exceed PCMAX.

When a UE transmits PSCCHs/PSSCHs on multiple carriers, the UE determines a power for each PSCCH/PSSCH transmission as described in 3GPP TS 38.213 [REF3] v18.0.0, “NR; Physical Layer Procedures for Control.”, Clauses 16.2.1 and 16.2.2, respectively. If the UE would transmit PSCCHs/PSSCHs that would overlap in time on respective carriers and a total power for the PSCCH/PSSCH transmissions would exceed PCMAX, the UE reduces a power for a PSCCH/PSSCH transmission that has the largest priority value as determined by SCI formats provided by the PSCCHs scheduling the respective PSSCHs. If more than one PSCCH/PSSCH transmission have the largest priority value, the UE autonomously selects one of the more than one PSCCH/PSSCH transmissions to reduce a respective power. If, after the reduction of the power for the PSCCH/PSSCH transmission with the largest priority value, a total power does not exceed PCMAX, the UE transmits the PSCCHs/PSSCHs, respectively. If, after the reduction of the power of the PSCCH/PSSCH transmission with the largest priority value, a total power exceeds PCMAX, the UE drops the PSCCH/PSSCH transmission with the largest priority value, respectively, and repeats the procedure over the remaining PSCCH/PSSCH transmissions.

When a UE simultaneously transmits PSFCHs and receive PSFCHs on multiple carriers, the UE performs the procedures described in 3GPP TS 38.213 [REF3] v18.0.0, “NR; Physical Layer Procedures for Control.”, Clause 16.2.4.2 by evaluating the PSFCHs for transmission and the PSFCHs for reception in order to determine either PSFCHs to transmit or PSFCHs to receive. When a UE simultaneously transmits PSFCHs on multiple carriers, the UE performs the procedures for single carrier in 3GPP TS 38.213 [REF3] v18.0.0, “NR; Physical Layer Procedures for Control.”, Clause 16.2.3 by evaluating the PSFCHs for transmission using a corresponding PCMAX in order to determine PSFCHs to transmit and a corresponding power per PSFCH transmission. The UE expects to determine a same time resource and a same power for each of the PSFCH transmissions on multiple carriers.

A description of example embodiments is provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. A first UE as UE-A and to second UE as UE-B is provided. In one example, UE-A is transmitting SL data on PSSCH/PSCCH, and UE-B is receiving the SL data on PSSCH/PSCCH.

In this disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In this disclosure MAC CE signaling includes: (1) MAC CE signaling over the Uu interface, and/or (2) MAC CE signaling over the PC5 or SL interface.

In this disclosure L1 control signaling includes: (1) L1 control signaling over the Uu interface, this can include (1a) DL control information (e.g., DCI on physical downlink control channel (PDCCH)) and/or (1b) UL control information (e.g., uplink control information (UCI) on physical uplink control channel (PUCCH) or physical uplink shared channel (PUSCH)), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In this disclosure, a carrier from the multiple carriers for SL CA can be identified for communication between a first UE and a second UE. In one example, for the first UE, a same carrier is used to transmit PSSCH/PSCCH and PSFCH from the first UE to the second UE. In one example, for the first UE, a same carrier is used to receive PSSCH/PSCCH and PSFCH at the first UE from the second UE. In one example, for the first UE, different carriers are used to transmit PSSCH/PSCCH and PSFCH from the first UE to the second UE. In one example, for the first UE, different carriers are used to receive PSSCH/PSCCH and PSFCH at the first UE from the second UE. In one example, for the first UE, different carriers are used to transmit PSSCH and PSCCH from the first UE to the second UE. In one example, for the first UE, different carriers are used to receive PSSCH and PSCCH at the first UE from the second UE. The roles of the first and second UEs can be interchanged.

In this disclosure, descriptions and examples for sidelink operation on two carriers equally apply to sidelink operation on more than two carriers, or to a set of carriers from the multiple carriers when the UE is configured for sidelink operation on multiple carriers that include one or more sets of carriers from the multiple carriers, and each set of carriers can include two or more carriers.

When a UE is configured for sidelink operation on multiple carriers, the UE can be configured with one or more resource pools for each of the multiple carriers, and transmissions and receptions of PSSCH, PSCCH, and PSFCH in each carrier are confined within and associated with the one or more resource pools configured for the corresponding carrier, with parameters (pre-)configured by higher layers for each carrier (e.g. SL-PSSCH-Config, SL-PSCCH-Config, and SL-PSFCH-Config, respectively). The UE performs the procedures for single carrier, as described in 3GPP TS 38.214 [REF4] v18.0.0, Clauses 8 and 8.1 for transmitting the PSSCH, in 3GPP TS 38.213 [REF3] v18.0.0, Clauses 16.4 for transmitting the PSCCH, and in 3GPP TS 38.213 [REF3] v18.0.0, Clauses 16.3.0 for transmitting the PSFCH, in each of the multiple carriers using corresponding configured resource pools.

A UE configured for sidelink operation on multiple carriers would be configured with higher layer parameter SL-PSFCH-Config for each of the multiple carriers. Fields of SL-PSFCH-Config determine PSFCH transmission occasion resources from a resource pool, can be set to same or different values for the multiple carriers, and the setting of the parameters can be done independently in each carrier or relatively among carriers. If a procedure for transmitting PSFCH would ensure that resources for PSFCHs are aligned in time over the multiple carriers, the procedure may be subject to different or additional rules and configurations depending on whether an SCI format scheduling a PSSCH reception that indicates to transmit a PSFCH with HARQ-ACK information in response to the PSSCH reception is transmitted on a same or different carrier of the carrier where the PSFCH is transmitted.

Thus, there is a need to identify rules and configurations to determine resources for PSFCH transmission occasions that are time aligned on the multiple carriers.

When a UE is configured for sidelink operation on multiple carriers, an SCI format scheduling a PSSCH reception on a first carrier can indicate to transmit a PSFCH with HARQ-ACK information in response to the PSSCH reception on a second carrier. Throughout this disclosure, this case is also referred as cross-carrier scheduling of a PSFCH transmission, and the first carrier is referred as the scheduling carrier. A slot, or generally PSFCH resources, on the second carrier identified for the PSFCH transmission in response to the PSSCH reception on the first carrier, may or may not be available for the PSFCH transmission. An unavailability of the slot may depend on the slot being identified for transmission of more than one PSFCH.

Thus, there is a need to determine resources for a PSFCH transmission on a carrier when the PSFCH transmission is in response to a PSSCH reception on another carrier.

There is another need to determine resources for a PSFCH transmission in a slot on a carrier when the PSFCH transmission is in response to a PSSCH reception on another carrier, and the slot is not available for the PSFCH transmission.

When a UE is configured for sidelink operation on multiple carriers and is configured with a resource pool for each of the multiple carriers, transmissions and receptions of PSSCH, PSCCH, and PSFCH use resources of the resource pool associated with the corresponding carrier. For example, if a UE is configured to operate with a first carrier f1 and a second carrier f2, and is configured with a corresponding first resource pool and a second resource pool, the UE can determine resources for transmissions and receptions of PSSCH, PSCCH, and PSFCH independently on each carrier.

For the first carrier f1, the UE determines the first set of slots assigned to the first sidelink resource pool using a first bitmap (b₀, b₁, . . . , b_{L}_{_{bitmap}}₋₁) associated with the first resource pool where L_{bitmap} is the length of the first bitmap configured by higher layers, and a slot tₖ^{SL} (0≤k<10240×2^{μ}-N_{S-SSB}−N_{nonSL}−N_{reserved}) belongs to the first set if bₖ′=1 where k′=k mod L_{bitmap}. The slots in the first set are re-indexed (logical slot index) such that the subscripts i of the remaining slots t′ᵢ^{SL} are successive {0, 1, . . . , T′ₘₐₓ−1} where T′ₘₐₓ is the number of the slots remaining in the set. The UE determines a slot t′ₖ^{SL} (0≤k<T′ₘₐₓ) that has a PSFCH transmission occasion resource from the slots of the first set if k mod N_{PSSCH}^{PSFCH}=0, where N_{PSSCH}^{PSFCH} is provided by higher layer parameter sl-PSFCH-Period for the first carrier. The UE transmits the PSFCH in a first slot that includes PSFCH resources and is at least a number of slots, provided by sl-MinTimeGapPSFCH for the first carrier of the resource pool after a last slot of the PSSCH reception.

For the second carrier f2, the UE determines the second set of slots assigned to the) associated with the second sidelink resource pool using a second bitmap b₀, b₁, . . . b_{L}_{_{bitmap}}₋₁) associated with the second resource pool where L_{bitmap} is the length of the second bitmap configured by higher layers, and a slot tₖ^{SL} (0≤k<10240×2^{μ}−N_{S-SSB}−N_{nonSL}−N_{reserved}) belongs to the second set if bₖ′=1 where k′=k mod L_{bitmap}. The slots in the second set are re-indexed (logical slot index) such that the subscripts i of the remaining slots t's are successive {0, 1, . . . , T′ₘₐₓ−1} where T′ₘₐₓ is the number of the slots remaining in the set. The UE determines a slot t′SL k<T′ₘₐₓ) that has a PSFCH transmission occasion resource from the slots of the second set if k mod N_{PSSCH}^{PSFCH}=0, where N_{PSSCH}^{PSFCH} is provided by higher layer parameter sl-PSFCH-Period for the second carrier. The UE transmits the PSFCH in a first slot that includes PSFCH resources and is at least a number of slots, provided by sl-MinTimeGapPSFCH for the second carrier of the resource pool after a last slot of the PSSCH reception.

When slots in the first set associated with the first carrier and slots in the second set associated with the second carrier are aligned in time domain, and the higher layer parameters sl-PSFCH-Period for the first carrier and sl-PSFCH-Period for the second carrier are set to the same value, then slots that include PSFCH resources in the two carriers are aligned in time. Depending on the type of traffic, sl-PSFCH-Period can be set differently for different carriers. For example, in one carrier the UE can be scheduled with more frequent PSSCH transmissions and/or there is a need to minimize the latency for receiving HARQ-ACK information in response to the PSSCH reception, and in another carrier the UE can be scheduled with long PSSCH transmissions. In this case sl-PSFCH-Period for the first carrier would be set to a smaller value than sl-PSFCH-Period for the second carrier. To minimize the number of slots that overlap in time and are slots with PSFCH in one carrier and without PSFCH in another carrier, sl-PSFCH-Period on one carrier can be set to a value that is a multiple of the value set on another carrier.

The UE can be configured with P₁ for sl-PSFCH-Period on the first carrier and P₂ for sl-PSFCH-Period on the second carrier, and P₂ is a multiple of P₁, with P₁=NP₂ with N larger than 1. The UE may transmit a PSFCH in any slot from the slots t′ₖ^{SL} (0≤k<T′ₘₐₓ) that have a PSFCH transmission occasion resource, wherein the PSFCH transmission occasion resource is determined based on P₁ for the first carrier and P₂ for the second carrier.

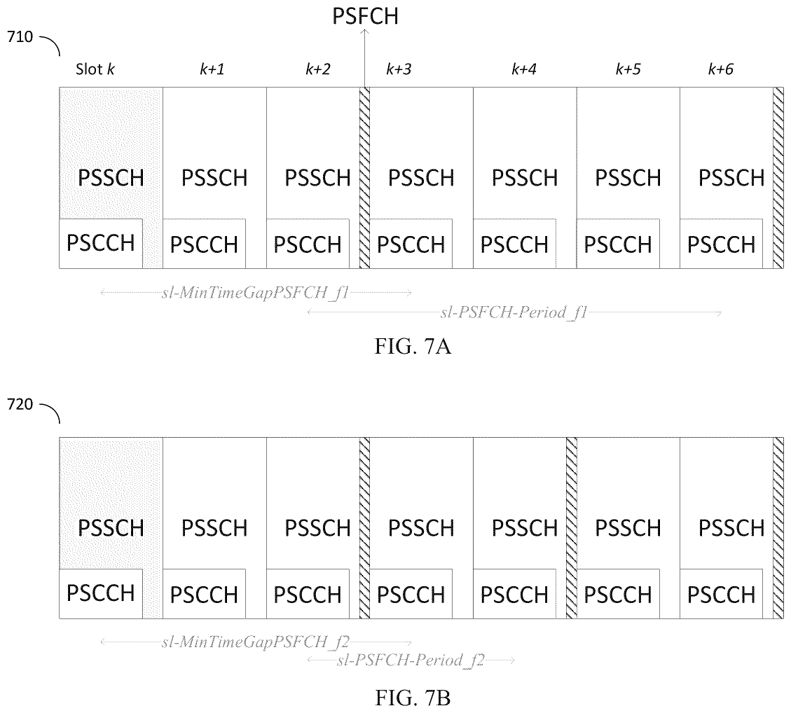

FIGS. 7A and 7B illustrates an example of a sidelink transmission and reception resources 710 and 720, respectively, according to embodiments of the present disclosure. For example, sidelink transmission and reception resources 710 and 720, respectively, can be utilized by any of the UEs 111-116 of FIG. 1, such as the UE 111A. This example is for illustration only and other embodiments can be used without departing from the scope of the present disclosure.

With reference to FIGS. 7A and 7B, an example of resources for sidelink transmissions and receptions on a first carrier f1 710 and a second carrier f2 720 is shown. For both carriers, higher layer parameters sl-MinTimeGapPSFCH-f1 and sl-MinTimeGapPSFCH-f2 are set to a same value of 3 slots. For the first carrier the higher layer parameter sl-PSFCH-Period-f1 is set to 4 slots and for the second carrier the higher layer parameter sl-PSFCH-Period-f2 is set to 2 slots. A higher layer parameter sl-MinTimeGapPSFCH can be set to a first value for the first carrier and to a second value for the second carrier. A higher layer parameter sl-PSFCH-Period can be set a first value for the first carrier and to a second value for the second carrier. A UE can transmit a PSFCH in any of the slots with PSFCH resources. Additionally, transmission of PSFCHs over the two carriers can also be constrained to time-aligned resources, and when the UE determines resources on the two carriers for corresponding PSFCH transmissions and the resources do not overlap in time, the UE postpones the transmission of the PSFCH to a next time-overlapping resource. For example, the indication to constrain PSFCH transmissions to time-aligned resources over the two carriers can be provided by a MAC CE, or by a field in an SCI format, and the UE applies the constraint until a new indication in MAC CE or in a SCI format is received, or until a certain time period expires. The time-aligned constrain refers to aligned slots with PSFCH resources and the PSFCH symbols within the slot may or may not be the same symbols on the two carriers. It may also refer to aligned symbols. Whether PSFCH transmissions over multiple carriers would be only in time aligned resources or not may depend on whether the UE operates in intra-band CA or inter-band CA.

In one example, the UE is further configured or indicated to transmits a PSFCH, on both carriers, in slots t′ₖ^{SL} (0≤k<T′ₘₐₓ) that have a PSFCH transmission occasion resource determined by P₁ which is the largest value from the configured values for sl-PSFCH-Period across the two carriers. Slots on the second carrier that have a PSFCH transmission occasion resource determined by P₂ and not overlapping with the slots on the first carrier that have a PSFCH transmission occasion resource determined by P₁ are unavailable for PSFCH transmission on the second carrier.

In one sub-example, when a UE determines a PSFCH transmission occasion for a PSFCH transmission in a slot in the second carrier that is unavailable as described herein, the UE postpones the PSFCH transmission in the next available slot in the second carrier, wherein the next available slot is a slot in the second carrier that has a PSFCH transmission occasion as determined based on P₂ and overlaps with a slot in the first carrier that has a PSFCH transmission occasion as determined based on P₁.

In one sub-example, when a UE determines a PSFCH transmission occasion for a PSFCH transmission in a slot in the second carrier that is unavailable as described herein, and the number of slots between the slot and the next available slot is larger than a (pre)configured value, the UE drops the PSFCH transmission in the slot in the second carrier.

Above sub-examples on postponing or dropping the PSFCH transmission in the slot in the second carrier also apply when an unavailability of the slot is determined based on a transmission power, for example a total transmission power for a first PSFCH transmission on the first carrier and a second PSFCH transmission on the second carrier in the slot or in the symbol exceeds a maximum power and the slot or the symbol is unavailable for the second PSFCH transmission on the second carrier, wherein the second PSFCH has lower priority than the first PSFCH or the second carrier has lower priority than the first carrier.

In one example, an indication to transmits the PSFCH, on both carriers, in slots t′ₖ^{SL} (0≤k<T′ₘₐₓ) that have a PSFCH transmission occasion resource determined by P₁ which is the largest value from the configured values for sl-PSFCH-Period across the two carriers, can be a 1-bit field of an SCI format, scheduling a PSSCH reception, that indicates to transmit a PSFCH on the second carrier with HARQ-ACK information in response to the PSSCH reception, wherein the second carrier is the carrier with the smallest value P₂, and the SCI format and the PSSCH reception are on the same carrier of the corresponding PSFCH transmission (second carrier). A value “0” of the 1-bit field of the SCI format indicates to transmit the PSFCH in a PSFCH transmission occasion determined using the value of sl-PSFCH-Period set for the corresponding carrier, and a value “1” of the 1-bit field of the SCI format indicates to transmit the PSFCH in a PSFCH transmission occasion determined using values of sl-PSFCH-Period set for both carriers, or equivalently for the example of P₁ being a multiple of P₂, with P₁=NP₂ with N larger than 1, using values of sl-PSFCH-Period for the first carrier. Thus, when the value “0” is indicated, a slot is available for transmission of the PSFCH on the second carrier if the slot has a PSFCH transmission occasion resource determined by P₂, and when the value “1” is indicated, a slot is available for transmission of the PSFCH on the second carrier if the slot has a PSFCH transmission occasion resource determined by P₁ and by P₂.

In case of multiple carriers, and values of the sl-PSFCH-Period for the multiple carriers being multiple of a smallest value corresponding to one of the multiple carriers, the indication in the SCI format can indicate whether to use a largest value of sl-PSFCH-Period from the values corresponding to the multiple carriers or use the sl-PSFCH-Period value set for the carrier where the PSFCH is transmitted.

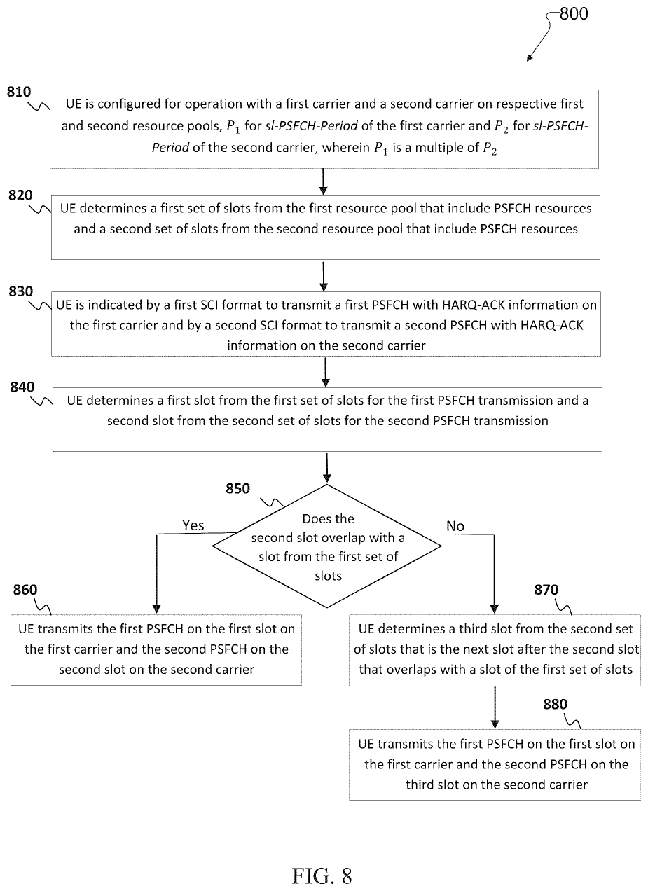

FIG. 8 illustrates a flowchart of an example UE procedure 800 for determining a slot for PSFCH transmission according to embodiments of the present disclosure. For example, UE procedure 800 for determining a slot for PSFCH transmission can be performed by any of the UEs 111-116 of FIG. 1, such as the UE 111B. This example is for illustration only and other embodiments can be used without departing from the scope of the present disclosure.

With reference to FIG. 8, an example procedure for a UE to determine a slot for a PSFCH transmission on a carrier when the UE is configured for sidelink operation on multiple carriers according to the disclosure is shown.

The procedure begins in 810, a UE is configured for operation with a first carrier and a second carrier on respective first and second resource pools, P₁ for sl-PSFCH-Period of the first carrier, P₂ for sl-PSFCH-Period of the second carrier, wherein P₁ is a multiple of P₂. In 820, the UE determines a first set of slots from the first resource pool that include PSFCH resources and a second set of slots from the second resource pool that include PSFCH resources. In 830, the UE is indicated by a first SCI format to transmit a first PSFCH with HARQ-ACK information on the first carrier and by a second SCI format to transmit a second PSFCH with HARQ-ACK information on the second carrier. In 840, the UE determines a first slot from the first resource pool for the first PSFCH transmission and a slot from the second resource pool for the second PSFCH transmission. In 850, the UE determines whether the second slot overlaps with a slot from the first set of slots. If the UE determines the second slot overlaps with a slot from the first set of slots, in 860, the UE transmits the first PSFCH on the first slot on the first carrier and the second PSFCH on the second slot on the second carrier. Otherwise, in 870, the UE determines a third slot from the second set of slots that is the next slot after the second slot that overlaps with a slot of the first set of slots. In 880, the UE transmits the first PSFCH on the first slot on the first carrier and the second PSFCH on the third slot on the second carrier.

When a UE is configured for sidelink operation on multiple carriers, an SCI format can schedule, on a first carrier, a PSSCH reception that indicates to transmit, on a second carrier, a PSFCH with HARQ-ACK information in response to the PSSCH reception. A slot on the second carrier, scheduled for the PSFCH transmission corresponding to the PSSCH reception on the first carrier, may or may not be available for the PSFCH transmission, and the unavailability may depend on a configuration of resources for PSFCH on the second carrier, and/or on more than one PSFCH scheduled by more than one carrier in the same slot on the second carrier.

The UE determines the slot for the PSFCH transmission on the second carrier based on a minimum number of slots after a last slot of the PSSCH reception provided by higher layer parameter sl-MinTimeGapPSFCH for the first carrier, and on a number of slots in a resource pool for a period of PSFCH transmission occasion resources provided by higher layer parameter sl-PSFCH-Period for the second carrier. The UE determines a candidate slot for the PSFCH transmission based on sl-MinTimeGapPSFCH, and if the candidate slot on the second carrier is not a slot for PSFCH transmission in the corresponding resource pool, the PSFCH is transmitted in the next slot for PSFCH transmission after the candidate slot.

The UE can be configured with a different value for the minimum number of slots after the last slot of the PSSCH reception for the case that the PSFCH is transmitted on a different carrier than the carrier for receiving the corresponding PSSCH. For example, the UE can be configured with a higher layer parameter sl-MinTimeGapPSFCH-cross-carrier for PSFCH cross-carrier that provides a value for the minimum number of slots. It is also feasible that the UE is provided a value for an additional number of slots relative to the minimum number of slots provided for the case of PSFCH same-carrier scheduling.

When a UE is configured for sidelink operation on multiple carriers, the UE can be configured for PSFCH cross-carrier scheduling, subject to a UE capability.

In one example, the UE is provided, by higher layers, an association between a first carrier where a PSSCH is received and a second carrier where a corresponding PSFCH that includes HARQ-ACK information in response to the PSSCH reception is transmitted. The UE transmits the PSFCH on the second carrier in response to the reception of the PSSCH in the first carrier.

In one example, the UE is indicated by an SCI format scheduling a PSSCH reception on a first carrier a second carrier where a corresponding PSFCH that includes HARQ-ACK information in response to the PSSCH reception is transmitted. The UE transmits the PSFCH on the second carrier in response to the reception of the PSSCH in the first carrier.

In one example, the UE is provided, by higher layers, an association between a carrier where a PSSCH is received and a set of carriers over which a corresponding PSFCH that includes HARQ-ACK information in response to the PSSCH reception can be transmitted. The UE is provided an indication of a carrier from the set of carriers for the corresponding PSFCH transmission by a 1-bit field in an SCI format scheduling the PSSCH reception.

In one example, the UE is provided, by higher layers, an association between a carrier where a PSSCH is received and a set of carriers over which a corresponding PSFCH that includes HARQ-ACK information in response to the PSSCH reception is transmitted. The UE repeats the PSFCH over multiple carriers from the set of carriers. The UE can be indicated by a SCI scheduling the PSSCH reception associated with the PSFCH transmission to transmit the PSFCH over multiple carriers. Subject to a configuration, the PSFCH transmissions can be in time aligned resources over the multiple carriers. For example, sl-MinTimeGapPSFCH (or MinTimeGapPSFCH-cross-carrier, if the UE is configured with different parameters for same-carrier and cross-carrier scheduling for the minimum number of slots after the last slot of the PSSCH reception for the PSFCH transmission) provides a single value.

When a UE is configured for sidelink operation on multiple carriers, for groupcast transmissions of PSSCH data on a group of carriers, the UE determines resources for PSFCH transmissions with HARQ-ACK information in response to PSSCH receptions in resource pools of the corresponding carriers. The UE transmits a group of PSFCHs using PSFCH resources of the multiple carriers, and the PSFCH transmission occasion resources overlap in time.

It is feasible that the UE (e.g., the UE 111) determines resources for PSFCH transmissions with HARQ-ACK information in response to PSSCH receptions in a resource pool of a carrier of the group of carriers, and the UE transmits a group of PSFCHs using the determined PSFCH resources of the carrier. The PSFCH transmission occasion resources can be in subsequent slots that have a PSFCH transmission resource according to a configuration (e.g., the higher layer parameter sl-PSFCH-Period of the carrier), and a starting slot can be a first slot that has a PSFCH transmission resource and is at least a number of slots, provided by sl-MinTimeGapPSFCH, of the resource pool after a last slot of the PSSCH reception. For a group of carriers, fᵢ, i=1, . . . , N, the starting slot is the slot with the PSFCH corresponding to carrier f1.

It is also feasible that the UE determines a resource for one PSFCH transmission with HARQ-ACK information in response to PSSCH receptions in a resource pool of a carrier of the group of carriers, wherein the carrier is configured by a higher layer parameter, or is indicated in an SCI format scheduling the PSSCH receptions, or is indicated by a MAC CE. The UE transmits the PSFCH using the determined PSFCH resource of the carrier.

When a UE is configured for sidelink operation on multiple carriers, the UE can be configured for PSFCH cross-carrier scheduling. For example, the UE is provided, by higher layers, an association between a set of carriers where PSSCHs are received and a carrier, also referred as a primary carrier, where PSFCHs that includes HARQ-ACK information in response to the PSSCH receptions are transmitted. The primary carrier may or may not be a carrier from the set of carriers. For each carrier of the set of carriers, when the UE is indicated by an SCI format scheduling a PSSCH reception to transmit a PSFCH with HARQ-ACK information in response to the PSSCH reception, the UE transmits the PSFCH on the primary carrier. Based on a last slot of the PSSCH reception on a carrier of the set of carriers, the UE determines a slot with PSFCH resources on the primary carrier for the corresponding PSFCH transmission. For PSSCH receptions on different carriers, the UE may determine a same slot for transmission of the corresponding PSFCHs.

When a UE determines a same slot k on a primary carrier for transmission of more than one PSFCH in response to PSSCH receptions on a set of carriers, and a slot format includes a resource of one symbol for PSFCH transmission, the UE selects a PSFCH to transmit based on one or more priority rules.

A priority can be associated with a carrier and can be configured by higher layer parameters or indicated in an SCI format scheduling the PSSCH reception, or by MAC CE. Only one carrier from the set of carriers can be configured as a high priority carrier and other carriers from the set of carriers are of equal low priority, or a priority for each of the carriers from the set of carriers can be configured. A bitmap with a length equal to the number of carriers in the set of carriers can be used to configure the priority, where the value ‘0’ indicates high priority and the value ‘1’ indicates low priority. If more than one carrier is configured with high priority, the UE uses an additional rule to select one carrier among the high priority carriers. For example, the UE may use a second step in the selection procedure a priority rule associated with the PSSCH reception. Alternatively, or additionally, when a priority for each of the carriers from the set of carriers is configured, the UE is provided a higher layer parameter that indicates the priority of each carrier. For example, if 8 carriers are configured for PSFCH cross-carrier scheduling, the higher layer parameter indicates per each carrier a priority value: value ‘000’ corresponds to priority value ‘1’, value ‘001’ corresponds to priority value ‘2’, and so on.

A priority can be associated with the PSSCH reception and indicated by a new field of an SCI format, e.g., PSFCH priority field, wherein the SCI format scheduling the PSSCH reception indicates to transmit a PSFCH with HARQ-ACK information in response to the PSSCH reception. The field indicating the priority associated with the PSSCH reception is present when the UE is configured for PSFCH cross-carrier scheduling and PSFCHs corresponding to PSSCH receptions on a set of carriers are transmitted on a same carrier.
In one example, the field includes a number of bits that depends on the number of carriers configured for the set of carriers. For example, if the set of carriers includes four carriers, the field includes 2 bits and the value ‘00’ corresponds to priority value ‘1’, value ‘01’ corresponds to priority value ‘2’, and so on.
In one example, the field includes 1 bit that indicates, and value ‘0’ correspond to high priority and value ‘1’ corresponds to low priority, or vice versa. The number of carriers can be two or higher.

Reserved bits of the SCI format 1-A can be used to indicate the priority, or the field indicating the priority associated with the PSSCH reception can be added in SCI format 2-A or SCI format 2-B, or in a new SCI format 2-D that is used for the decoding of PSSCH, with HARQ operation when HARQ-ACK information includes ACK or NACK, when HARQ-ACK information includes only NACK, or when there is no feedback of HARQ-ACK information, for operation with multiple carriers and/or with cross-carrier PSFCH scheduling. In the SCI format 1-A, the field 2nd-stage SCI format of 2 bits with value ‘11’ as defined in Table 8.3.1.1-1 of TS 38.213 [REF3], clause 8.3.1.1 as reserved, can be used to indicate the new SCI format 2-D for operation with multiple carriers and/or cross-carrier PSFCH scheduling. Alternatively, two new SCI format can be introduced for operation with multiple carriers. An SCI format 2-A1 for operation with multiple carriers, used for the decoding of PSSCH, with HARQ operation when HARQ-ACK information includes ACK or NACK, when HARQ-ACK information includes only NACK, or when there is no feedback of HARQ-ACK information, which includes a PSFCH priority field of 1 or more bits. An SCI format 2-B1 for operation with multiple carriers, used for the decoding of PSSCH, with HARQ operation when HARQ-ACK information includes only NACK, or when there is no feedback of HARQ-ACK information, which includes a PSFCH priority field of 1 or more bits. Additionally, or alternatively to the presence of the PSFCH priority field, the SCI format 2-A1 or SCI format 2-B1 for operation with multiple carriers can include a carrier indication field that indicates a carrier from a second set of carriers, wherein the second set of carriers is configured for PSFCH transmissions and the indicated carrier is used for the PSFCH transmission corresponding to the PSSCH reception scheduled by SCI format 2-A1 or SCI format 2-B1.

A priority can be associated with the PSSCH reception and indicated by an existing field of the SCI format scheduling the PSSCH reception as described in TS 38.213 [REF3], clause 8.3.1.1 for SCI format 1-A, clause 8.4.1 for 2nd-stage SCI formats. In one example, the HARQ feedback enabled/disabled indicator in SCI format 1-B can be repurposed, subject to a configuration, to indicate the priority associated with the PSFCH that includes a NACK, or to indicate the priority associated with the PSFCH that may include an ACK or a NACK. In one example, the priority value for the PSFCH transmission on the primary carrier is equal to the priority value indicated by an SCI format 1-A associated with the PSFCH.

If more than one priority rule exists, the UE selects the PSFCH to transmit based on the priority associated with the carrier, if any, otherwise based on the PSSCH transmission. Equal priorities based on the priority associated with the carrier can be resolved by applying the priority based on the PSSCH transmission.

Priority rules described herein for PSSCHs reception on multiple carriers also apply when the multiple PSSCH receptions are on a first carrier and corresponding PSFCHs are on a second carrier.

When a UE determines a same slot k on a primary carrier for transmission of Nₚ PSFCH in response to PSSCH receptions on a set of carriers, and a slot format of slot k includes a resource of one symbol for PSFCH transmission, the UE selects a PSFCH from the Nₚ PSFCH based on one or more priority rules. The UE transmits the selected PSFCH in slot k on a primary carrier and transmits the Nₚ-1 PSFCHs in subsequent slots with PSFCH resources, according to a priority. If the Nₚ-1 PSFCHs, or some of the PSFCHs have equal priority after the UE applied one or more priority rules, the UE determines the transmission order arbitrarily.

A UE configured for sidelink operation on multiple carriers would be configured with higher layer parameter SL-PSFCH-Config for each of the multiple carriers. Fields of SL-PSFCH-Config determine PSFCH transmission occasion resources from a resource pool, can be set to same or different values for the multiple carriers, and the setting of the parameters can be done independently in each carrier or relatively among carriers. An SCI format scheduling a PSSCH reception on a first carrier can indicate to transmit a PSFCH with HARQ-ACK information in response to the PSSCH reception on a different carrier from the first carrier in a slot k with PSFCH resources. Throughout this disclosure, this case is also referred as cross-carrier scheduling of a PSFCH transmission, and the first carrier is referred as the scheduling carrier. It is feasible that more than one scheduling carrier indicate to transmit respective PSFCHs in a same carrier, e.g., a primary carrier, and more than one PSFCH may be scheduled in slot k. The primary carrier can be a dedicated carrier for transmissions of PSFCHs in response to PSSCHs receptions on carriers different from the primary carrier. Alternatively, or additionally, a PSFCH in response to a PSSCH reception on the primary carrier, if any, can be also transmitted on the primary carrier. In order to improve sidelink resource allocation and reduce a HARQ-ACK information reporting latency it is beneficial to allow multiple PSFCH transmissions in a slot of the primary carrier.

Therefore, there is a need to define a slot format that allows multiple PSFCH transmissions in a slot on a carrier, wherein the multiple PSFCH transmissions are in response to PSSCH receptions on carriers different than the carrier with PSFCH transmissions, or in response to PSSCH receptions on same and different carriers than the carrier with PSFCH transmissions.

For sidelink operation on a carrier, to improve a reception reliability for a PSFCH transmission with HARQ-ACK information in response to a PSSCH reception, the PSFCH transmission can be repeated a number of times over a number of slots. To improve sidelink resource allocation and reduce a HARQ-ACK information reporting latency it is beneficial to allow multiple repetitions of a PSFCH transmission in a slot in order to improve utilization of available resources within a given time period and reduce a time required for completing a number of repetitions.

Therefore, there is a need to provide signalling mechanisms to indicate a number of repetitions.

There is another need to provide means for determining symbols to use for a number of repetitions of a transmission, such as for a PSFCH, over a number of slots.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 KHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, and physical SL Broadcast channel (PSBCH) conveying system information to assist in SL synchronization. SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH, and the second SCI format is multiplexed along with SL data on a PSSCH that is transmitted in physical resources indicated by the first SCI format.

A transport block (TB) is carried in a PSSCH. The SCI indicates the resources used by the PSSCH that carries the associated TB, as well as further information required for decoding the TB. A PSCCH is sent with a PSSCH. The SCI is transmitted in two stages: 1st-stage SCI is carried on the PSCCH, and 2nd-stage SCI is carried on the corresponding PSSCH, and such flexible SCI design can support unicast, groupcast, and broadcast transmissions. Splitting the SCI in two stages (1 st-stage SCI and 2nd-stage SCI) allows other UEs which are not RX UEs of a transmission to decode only the 1st-stage SCI for channel sensing purposes, i.e., for determining the resources reserved by other transmissions. On the other hand, the 2nd-stage SCI provides additional control information which is required for the RX UE(s) of a transmission.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to surrounding UEs. In NR release 16, there are two resource allocation modes for a PSCCH/PSSCH transmission. In resource allocation mode 1, a gNB (e.g., the gNB 102) schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where UEs have no communication with any gNB, or with partial network coverage, where only some UEs are within the communication range of a gNB.

In case of groupcast PSCCH/PSSCH transmission, a network can configure a UE one of two options for reporting of HARQ-ACK information by the UE:
HARQ-ACK reporting option (1): A UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB.
HARQ-ACK reporting option (2): A UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option (1), when a UE that transmitted the PSSCH detects a NACK in a PSFCH reception, the UE can transmit another PSSCH with the TB (retransmission of the TB). In HARQ-ACK reporting option (2) when a UE that transmitted the PSSCH does not detect an ACK in a PSFCH reception, such as when the UE detects a NACK or does not detect a PSFCH reception, the UE can transmit another PSSCH with the TB.

Transmission and reception of PSSCH, PSCCH, and PSFCH are confined within and associated with a resource pool, with parameters (pre-)configured by higher layers (e.g. SL-PSSCH-Config, SL-PSCCH-Config, and SL-PSFCH-Config, respectively).

A UE transmits the PSSCH in consecutive symbols within a slot of the resource pool, and PSSCH resource allocation starts from the second symbol configured for sidelink, e.g. startSLsymbol+1, and the first symbol configured for sidelink is duplicated from the second configured for sidelink, for AGC purpose. The UE does not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool, by a higher layer parameter sl-TimResourcePSCCH, starting from the second symbol configured for sidelink, e.g. startSLsymbol+1; and further provided a number of RBs in the resource pool, by a higher layer parameter sl-FreqResourcePSCCH, starting from the lowest RB of the lowest sub-channel of the associated PSSCH.

A UE can be provided a number of slots by a higher layer parameter sl-PSFCH-Period in the resource pool for a period of PSFCH transmission occasion resources, and a slot in the resource pool is determined as containing a PSFCH transmission occasion, if the relative slot index within the resource pool is an integer multiple of the period of PSFCH transmission occasion, and with at least a number of slots provided by a higher layer parameter sl-MinTimeGapPSFCH after the last slot of the PSSCH reception. PSFCH is transmitted in two contiguous symbols in a slot, wherein the second symbol is with index startSLsymbols+lengthSLsymbols−2, and the two symbols are repeated.

A sidelink resource pool includes a set/pool of slots and a set/pool of RBs used for sidelink transmission and sidelink reception. A set of slots that belongs to a sidelink resource pool can be denoted by {t′₀^{SL}, t′₁^{SL}, t′₂^{SL}, . . . , t′_{T′MAX-1}^{SL}} and can be configured, for example, at least using a bitmap. T′ₘₐₓ is the number of SL slots in a resource pool within 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}−1, n_{subCHstart} and n_{subCHsize} are provided by higher layer parameters.

The slots of a SL resource pool are determined as follows:
4. A set of slots that may belong to a resource pool can be denoted by {t′₀^{SL}, t′₁^{SL}, t′₂^{SL}, . . . , t′_{T′MAX-1}^{SL}}, where 0≤tᵢ^{SL}<10240×2^{μ}, and 0≤i<Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=8 for a 120 kHz sub-carrier spacing. The slot index is relative to slot #0 of SFN #0 of the serving cell, or DFN #0. The set of slots includes slots except:
   a. N_{S-SSB} slots that are configured for SL SS/PBCH Block (S-SSB).
   b. N_{nonSL} slots where at least one SL symbol is not semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   c. N_{reserved} reserved slots. Reserved slots are determined such that the slots in the set {t′₀^{SL}, t′₁^{SL}, t′₂^{SL}, . . . , t′_{T′MAX-1}^{SL}} is a multiple of the bitmap length (L_{bitmap}), where the bitmap (b₀, b₁, . . . , b_{L}_{_{bitmap}}₋₁) is configured by higher layers. The reserved slots are determined as follows:
      i. Let {l₀, l₁, . . . , l₂_{^{μ}}_{×10240-N}_{_{S-SSB}}_{-N}_{_{nonSL}}₋₁)} be the set of slots in range 0 . . . 2^{μ}×10240−1, excluding S-SSB slots and non-SL slots. The slots are arranged in ascending order of the slot index.
      ii. The number of reserved slots is given by: N_{reserved}=(2^{μ}×10240−N_{S-SSB}−N_{nonSL}) mod L_{bitmap}.
      iii. The reserved slots lᵣ are given by:

$$r = ⌊ \frac{m \cdot ( {2}^{μ} \times 10240 - {N}_{S - SSB} - {N}_{nonSL} )}{{N}_{reserved}} ⌋ ,$$

where m=0, 1, . . . , N_{reserved}−1
Tₘₐₓ is given by: Tₘₐₓ=2^{μ}×10240−N_{S-SSB}−N_{nonSL}−N_{reserved}.
5. The slots in the set are arranged in ascending order of slot index.
6. The set of slots belonging to the SL resource pool, {t′₀^{SL}, t′₁^{SL}, t′₂^{SL}, . . . , t′_{T′MAX-1}^{SL}}, are determined by the UE as follows:
   a. Each resource pool has a corresponding bitmap (b₀, b₁, . . . , b_{L}_{_{bitmap}}₋₁) L_{bitmap}.
   b. A slot tₖ^{SL} belongs to the SL resource pool if b_{k mod L}_{_{bitmap}}=1.
   c. The remaining slots in the set, t′ᵢ^{SL}, are indexed successively starting from 0, 1, . . . . T′ₘₐₓ−1, where T′ₘₐₓ is the number of remaining slots in the set.

Slots can be numbered (indexed) as physical slots or logical slots, wherein physical slots include slots numbered sequential, while logical slots include only slots that can be allocated to sidelink resource pool as described herein numbered sequentially. The conversion from a physical duration, Pᵣₛᵥₚ, in milli-second to logical slots, P′ᵣₛᵥₚ, is given by

$${P}_{rsvp}^{′} = ⌈ \frac{{T}_{max}^{′}}{1 \; 0240 ms} \times {P}_{rsvp} ⌉$$

(as described in 3GPP TS 38.214 [REF4], Clause 8.1.7).

For a PSCCH transmission with a SCI format 1-A, a UE can be provided a number of symbols in a resource pool, by a higher layer parameter sl-TimeResourcePSCCH, starting from a second symbol that is available for SL transmissions in a slot, and a number of PRBs in the resource pool, by a higher layer parameter sl-FreqResourcePSCCH, starting from the lowest PRB of the lowest sub-channel of the associated PSSCH. A UE that transmits a PSCCH with SCI format 1-A using sidelink resource allocation mode 2 or mode 1 sets the values of the frequency resource assignment field and the time resource assignment field as described in 3GPP TS 38.213 [REF3] Clause 16.4.

A UE can be indicated by an SCI format scheduling a PSSCH reception to transmit a PSFCH with HARQ-ACK information in response to the PSSCH reception. The UE provides HARQ-ACK information that includes ACK or NACK, or only NACK. The UE can be provided a number of slots in a resource pool for a period of PSFCH transmission occasion resources by a higher layer parameter sl-PSFCH-Period. If the number is zero, PSFCH transmissions from the UE in the resource pool are disabled.

A UE expects that a slot t′ₖ^{SL} (0≤k<T′ₘₐₓ) has a PSFCH transmission occasion resource if k mod N_{PSSCH}^{PSFCH}=0, where t′ₖ^{SL} is a logical slot and T′ₘₐₓ is a number of slots that N_{PSSCH} belong to the resource pool within 10240 msec, as previously described. N_{PSSCH}^{PSFCH} is provided by the higher layer parameter sl-PSFCH-Period.

A UE may be indicated by higher layers to not transmit a PSFCH that includes HARQ-ACK information in response to a PSSCH reception.

If a UE receives a PSSCH in a resource pool and the HARQ feedback enabled/disabled indicator field in an associated SCI format 2-A/2-B/2-C has value 1, the UE provides the HARQ-ACK information in a PSFCH transmission in the resource pool. The UE transmits the PSFCH in a first slot that includes PSFCH resources and is at least a number of slots, provided by higher layer parameter sl-MinTimeGapPSFCH, of the resource pool after a last slot of the PSSCH reception.

A UE can be provided by higher layer parameter sl-PSFCH-RB-Set a set of M_{PRB, set}^{PSFCH} PRBs in a resource pool for PSFCH transmission with HARQ-ACK information in a PRB of the resource pool. A UE can be provided by higher layer parameter sl-RB-SetPSFCH a set of M_{PRB, set}^{PSFCH} PRBs in a resource pool for PSFCH transmission with conflict information in a PRB of the resource pool. Different PRBs are (pre)configured for conflict information and HARQ-ACK information. For a number of N_{subch} sub-channels for the resource pool, provided by higher layer parameter sl-NumSubchannel, and a number of PSSCH slots associated with a PSFCH slot that is less than or equal to N_{PSSCH}^{PSFCH} PSSCH, the UE allocates the [(i+j·N_{PSSCH}^{PSFCH})·M_{subch, slot}^{PSFCH}, (i+1+j·N_{PSSCH}^{PSFCH})·M_{subch, slot}^{PSFCH}−1] PRBs from the M_{PRB, set}^{PSFCH} PRBs to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSFCH}^{PSSCH}, 0≤j<N_{subch}, and the allocation starts in an ascending order of i and continues in an ascending order of j. M_{PRB, set}^{PSFCH} is a multiple of N_{subch}·N_{PSSCH}^{PSFCH}.

A UE (e.g., the UE 111) determines a number of PSFCH resources available for multiplexing HARQ-ACK or conflict information in a PSFCH transmission as R_{PRB, CS}^{PSFCH}=N_{type}^{PSFCH}·M_{subch, slot}^{PSFCH}·N_{CS}^{PSFCH} where N_{SC}^{PSFCH} is a number of cyclic shift pairs for the resource pool provided by higher layer parameter sl-NumMuxCS-Pair and, based on an indication by higher layer parameter sl-PSFCH-CandidateResourceType,
N_{type}^{PSFCH} and the M_{subch, slot}^{PSFCH} PRBs are associated with the starting sub-channel of the corresponding PSSCH if sl-PSFCH-Candidate Resource Type is configured as startSubCH, and
N_{type}^{PSFCH}=N_{PSSCH}^{PSFCH} and the N_{subch}^{PSFCH}·M_{subch, slot}^{PSFCH} PRBs are associated with the N_{subch}^{PSSCH} sub-channels of the corresponding PSSCH, if sl-PSFCH-Candidate Resource Type is configured as allocSubCH.

For conflict information, the corresponding PSSCH is determined based on sl-PSFCH-Occasion.

The PSFCH resources are first indexed according to an ascending order of the PRB index, from the N_{type}^{PSFCH}·M_{subch, slot}^{PSFCH} PRBs, and then according to an ascending order of the cyclic shift pair index from the N_{SC}^{PSFCH} cyclic shift pairs.

A UE determines an index of a PSFCH resource, for a PSFCH transmission with HARQ-ACK information in response to a PSSCH reception or with conflict information, corresponding to a reserved resource as (P_{ID}+M_{ID}) mod R_{PRB, CS}^{PSFCH} where P_{ID} is a physical layer source ID provided by SCI format 2-A/2-B/2-C scheduling the PSSCH reception, or by SCI format 2-A/2-B/2-C with corresponding SCI format 1-A reserving the resource from another UE to be provided with the conflict information. For HARQ-ACK information, M_{ID} is the identity of the UE receiving the PSSCH as indicated by higher layers if the UE detects a SCI format 2-A with Cast type indicator field value of “01”; otherwise, M_{ID} is zero. For conflict information, M_{ID} is zero.

For LTE SL, a UE can operate with sidelink carrier aggregation (SL CA) for some modes of resource allocation (modes 3 and 4). When operating with CA, a given (sidelink) MAC PDU is transmitted, and if necessary re-transmitted, on a single sidelink carrier, and multiple MAC PDUs can be transmitted in parallel on different carriers. This provides a throughput gain in a similar way as for Uu CA. It is also feasible that the UE allowed to transmit and receive on multiple sidelink carriers (pre)configured by the network (e.g., the network 130) can select specific sidelink one or more carriers among them for transmission.

SL CA for resource allocation mode 3 using a dynamic grant is similar to the CA operation on the Uu interface that includes a carrier indication field (CIF) in the DCI from the eNB. This indicates which among the up to 8 configured sidelink carriers the allocation in the DCI applies to.

SL CA for resource allocation mode 4 uses a sensing procedure to select resources independently on each involved carrier. The same carrier is used for MAC PDUs of the same SL process at least until the process triggers resource re-selection. Procedures to avoid unexpected UE behavior when the demands of CA become high allow a UE to drop a transmission which uses an excessive amount of resources or transmit chains, or to reject and re-select resources for which it cannot meet the RF requirements under CA.

For synchronization in LTE SL CA operation, a SyncRef UE uses a single synchronization reference for aggregated carriers, and may transmit SLSS/PSBCH on one or multiple carriers according to a capability. A receiving UE uses the same synchronization reference (not necessarily a SyncRef UE) for its aggregated carriers, and it uses the highest priority synchronization reference present among the available synchronization carriers.

For NR SL, a UE can be configured for sidelink operation on multiple carriers and transmit S-SS/PSBCH blocks on multiple carriers with a power for each S-SS/PSBCH block transmission derived as in 3GPP TS 38.213 [REF3] v18.0.0, “NR; Physical Layer Procedures for Control.”, Clause 16.2.0. If transmitted S-SS/PSBCH blocks would overlap in time on respective carriers and a total power for the transmissions of the S-SS/PSBCH blocks would exceed PCMAX, the UE reduces a power for one or more of the S-SS/PSBCH blocks transmissions so that a resulting total power would not exceed PCMAX.

When a UE transmits PSCCHs/PSSCHs on multiple carriers, the UE determines a power for each PSCCH/PSSCH transmission as described in 3GPP TS 38.213 [REF3] v18.0.0, “NR; Physical Layer Procedures for Control.”, Clauses 16.2.1 and 16.2.2, respectively. If the UE would transmit PSCCHs/PSSCHs that would overlap in time on respective carriers and a total power for the PSCCH/PSSCH transmissions would exceed PCMAX, the UE reduces a power for a PSCCH/PSSCH transmission that has the largest priority value as determined by SCI formats provided by the PSCCHs scheduling the respective PSSCHs. If more than one PSCCH/PSSCH transmission have the largest priority value, the UE autonomously selects one of the more than one PSCCH/PSSCH transmissions to reduce a respective power. If, after the reduction of the power for the PSCCH/PSSCH transmission with the largest priority value, a total power does not exceed PCMAX, the UE transmits the PSCCHs/PSSCHs, respectively. If, after the reduction of the power of the PSCCH/PSSCH transmission with the largest priority value, a total power exceeds PCMAX, the UE drops the PSCCH/PSSCH transmission with the largest priority value, respectively, and repeats the procedure over the remaining PSCCH/PSSCH transmissions.

When a UE simultaneously transmits PSFCHs and receive PSFCHs on multiple carriers, the UE performs the procedures described in 3GPP TS 38.213 [REF3] v18.0.0, “NR; Physical Layer Procedures for Control.”, Clause 16.2.4.2 by evaluating the PSFCHs for transmission and the PSFCHs for reception in order to determine either PSFCHs to transmit or PSFCHs to receive. When a UE simultaneously transmits PSFCHs on multiple carriers, the UE performs the procedures for single carrier in 3GPP TS 38.213 [REF3] v18.0.0, “NR; Physical Layer Procedures for Control.”, Clause 16.2.3 by evaluating the PSFCHs for transmission using a corresponding PCMAX in order to determine PSFCHs to transmit and a corresponding power per PSFCH transmission. The UE expects to determine a same time resource and a same power for each of the PSFCH transmissions on multiple carriers.

When a UE is configured for sidelink operation on multiple carriers, the UE can be configured with one or more resource pools for each of the multiple carriers, and transmissions and receptions of PSSCH, PSCCH, and PSFCH in each carrier are confined within and associated with the one or more resource pools configured for the corresponding carrier, with parameters (pre-)configured by higher layers for each carrier (e.g. SL-PSSCH-Config, SL-PSCCH-Config, and SL-PSFCH-Config, respectively). The UE performs the procedures for single carrier, as described in 3GPP TS 38.214 [REF4] v18.0.0, Clauses 8 and 8.1 for transmitting the PSSCH, in 3GPP TS 38.213 [REF3] v18.0.0, Clauses 16.4 for transmitting the PSCCH, and in 3GPP TS 38.213 [REF3] v18.0.0, Clauses 16.3.0 for transmitting the PSFCH, in each of the multiple carriers using corresponding configured resource pools.

In SL, “reference RS” can correspond to a set of characteristics for SL beam, such as a direction, a precoding/beamforming, a number of ports, and so on. This can correspond to a SL receive beam or to a SL transmit beam. At least two UEs are involved in a SL communication. A first UE as UE-A and to second UE as UE-B is provided. In one example, UE-A is transmitting SL data on PSSCH/PSCCH, and UE-B is receiving the SL data on PSSCH/PSCCH.

In this disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In this disclosure MAC CE signaling includes: (1) MAC CE signaling over the Uu interface, and/or (2) MAC CE signaling over the PC5 or SL interface.

In this disclosure L1 control signaling includes: (1) L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In this disclosure, a carrier from the multiple carriers for SL CA can be identified for communication between a first UE and a second UE. In one example, for the first UE, a same carrier is used to transmit PSSCH/PSCCH and PSFCH from the first UE to the second UE. In one example, for the first UE, a same carrier is used to receive PSSCH/PSCCH and PSFCH at the first UE from the second UE. In one example, for the first UE, different carriers are used to transmit PSSCH/PSCCH and PSFCH from the first UE to the second UE. In one example, for the first UE, different carriers are used to receive PSSCH/PSCCH and PSFCH at the first UE from the second UE. In one example, for the first UE, different carriers are used to transmit PSSCH and PSCCH from the first UE to the second UE. In one example, for the first UE, different carriers are used to receive PSSCH and PSCCH at the first UE from the second UE. The roles of the first and second UEs can be interchanged.

In this disclosure, descriptions and examples for sidelink operation on two carriers equally apply to sidelink operation on more than two carriers, or to a set of carriers from the multiple carriers when the UE is configured for sidelink operation on multiple carriers that include one or more sets of carriers from the multiple carriers, and each set of carriers can include two or more carriers.

A UE configured for sidelink operation on multiple carriers would be configured with higher layer parameter SL-PSFCH-Config for each of the multiple carriers. Fields of SL-PSFCH-Config determine PSFCH transmission occasion resources from a resource pool, can be set to same or different values for the multiple carriers, and the setting of the parameters can be done independently in each carrier or relatively among carriers. An SCI format scheduling a PSSCH reception on a first carrier can indicate to transmit a PSFCH with HARQ-ACK information in response to the PSSCH reception on a different carrier from the first carrier in a slot k with PSFCH resources. Throughout this disclosure, this case is also referred as cross-carrier scheduling of a PSFCH transmission, and the first carrier is referred as the scheduling carrier. It is feasible that more than one scheduling carrier indicate to transmit respective PSFCHs in a same carrier, e.g., a primary carrier, and more than one PSFCH may be scheduled in slot k. The primary carrier can be a dedicated carrier for transmissions of PSFCHs in response to PSSCHs receptions on carriers different from the primary carrier. Alternatively, or additionally, a PSFCH in response to a PSSCH reception on the primary carrier, if any, can be also transmitted on the primary carrier. In order to improve sidelink resource allocation and reduce a HARQ-ACK information reporting latency it is beneficial to allow multiple PSFCH transmissions in a slot of the primary carrier.

Therefore, there is a need to define a slot format that allows multiple PSFCH transmissions in a slot on a carrier, wherein the multiple PSFCH transmissions are in response to PSSCH receptions on carriers different than the carrier with PSFCH transmissions, or in response to PSSCH receptions on same and different carriers than the carrier with PSFCH transmissions.

For sidelink operation on a carrier, to improve a reception reliability for a PSFCH transmission with HARQ-ACK information in response to a PSSCH reception, the PSFCH transmission can be repeated a number of times over a number of slots. To improve sidelink resource allocation and reduce a HARQ-ACK information reporting latency it is beneficial to allow multiple repetitions of a PSFCH transmission in a slot in order to improve utilization of available resources within a given time period and reduce a time required for completing a number of repetitions.

Therefore, there is a need to provide signalling mechanisms to indicate a number of repetitions.

There is another need to provide means for determining symbols to use for a number of repetitions of a transmission, such as for a PSFCH, over a number of slots.

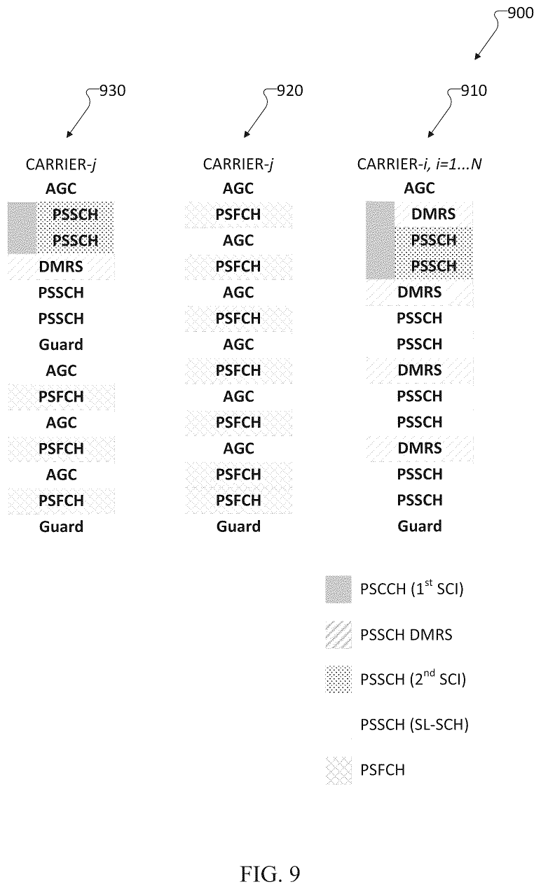

FIG. 9 illustrates a diagram of example slot formats 900 for sidelink operation according to embodiments of the present disclosure. For example, slot formats 900 for sidelink operation can be utilized by any of the UEs 111-116 of FIG. 1, such as the UE 111C. This example is for illustration only and other embodiments can be used without departing from the scope of the present disclosure.

With reference to FIG. 9, examples of slot formats for sidelink operation on multiple carriers is shown. On each carrier i with i=1, . . . , N, an SCI format scheduling a PSSCH reception indicates to transmit HARQ-ACK information in response to the PSSCH receptions on a carrier j that is different from carrier i. The slot format of the N carriers illustrated in FIG. 9 does not include PSFCH symbols 910, and PSFCHs corresponding to the PSSCH receptions on the N carriers are transmitted on PSFCH resources available on carrier j.

A slot format with PSFCH resources on carrier j can include only PSFCH symbols 920. The automatic gain control (AGC) symbol is a duplication of the PSFCH symbol and is used to adjust the power of the received signal in order to reduce the quantization error or the clipping of the signal at the analog to digital converter (ADC) since the received signal power can vary over a wide dynamic range depending on the channel attenuation and interference. Subsequent PSFCHs in different symbols can correspond to different PSSCHs that are received on different carriers, and the symbol before each PSFCH symbol is an AGC symbol. Subsequent PSFCHs in different symbols can correspond to different PSSCHs that are received on a same carrier, and the symbol before each PSFCH symbol is an AGC symbol. It is feasible that for PSFCHs in response to PSSCHs that are received over a same carrier i, a single AGC symbol is used. For example, symbols 11 and 12 on carrier j are used for PSFCHs in response to PSSCHs that are received on the same carrier i and a single AGC symbol in symbol 10 is used. Whether there is a single AGC symbol for more than one PSFCH or an AGC symbol for each PSFCH, for PSFCH transmissions in response to more than one PSSCH receptions on the same carrier, can be subject to a configuration, or a UE capability, or a gap in number of slots or number of symbols between last slots or last symbols of the PSSCH receptions of two subsequent PSSCH receptions. Slots for which the UE expects that at least a PSFCH resource is available can be determined according to higher layer parameters sl-MinTimeGapPSFCH and sl-PSFCH-Period, and the UE expects that a slot t′ₖ^{SL} (0≤k<T′ₘₐₓ) has a PSFCH transmission occasion resource if k mod N_{PSSCH}^{PSFCH}=0, where t′ₖ^{SL} is defined in TS 38.214 [REF4], and T′ₘₐₓ is a number of slots that belong to the resource pool within 10240 msec according to TS 38.214 [REF4], and N_{PSSCH}^{PSFCH} is provided by sl-PSFCH-Period. The slot t′ₖ^{SL} can be configured with a slot format with only PSFCH symbols (and associated AGC symbols).

The slot format with PSFCH resources used on the carrier j can include multiple PSFCH symbols, and PSCCH/PSSCH symbols 930. Subsequent PSFCHs in different symbols can correspond to different PSSCHs that are received on different carriers, and the symbol before each PSFCH symbol is an AGC symbol. Subsequent PSFCHs in different symbols can correspond to different PSSCHs that are received on a same carrier, and the symbol before each PSFCH symbol is an AGC symbol. It is feasible that for PSFCHs in response to PSSCHs over a same carrier i, a single AGC symbol is used. Whether there is a single AGC symbol for more than one PSFCH or an AGC symbol for each PSFCH, for PSFCH transmissions in response to PSSCH receptions on the same carrier, can be subject to the gap in number of slots or number of symbols between last slots or last symbols of the PSSCH receptions of two subsequent PSSCH receptions. The slots t′ₖ^{SL} where the UE expects at least a PSFCH resource is available can be determined according to higher layer parameters sl-MinTimeGapPSFCH and sl-PSFCH-Period, and each slot t′ₖ^{SL} can be configured with a slot format with multiple PSFCH symbols (and associated AGC symbols).

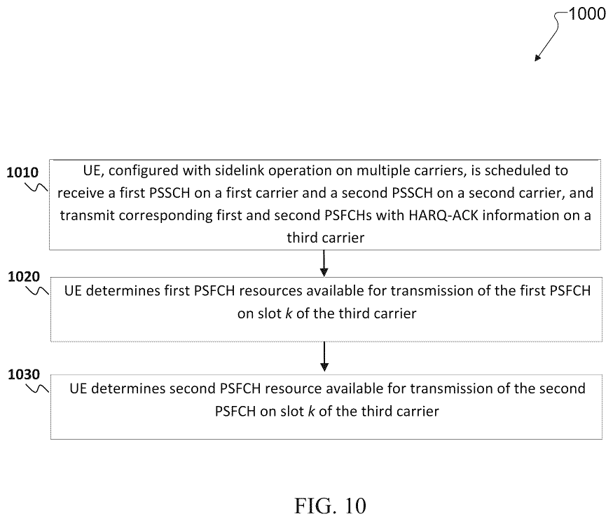

FIG. 10 illustrates a flowchart of an example UE procedure 1000 for receiving PSSCHs and transmitting corresponding PSFCHs according to embodiments of the present disclosure. For example, procedure 1000 for receiving PSSCHs and transmitting corresponding PSFCHs can be performed by any of the UEs 111-116 of FIG. 1, such as the UE 111. This example is for illustration only and other embodiments can be used without departing from the scope of the present disclosure.

With reference to FIG. 10, an example procedure for a UE to receive PSSCHs and transmit corresponding PSFCHs on different carriers according to the disclosure is shown.

The procedure begins in 1010, a UE, configured with sidelink operation on multiple carriers, is scheduled to: receive a first PSSCH on a first carrier and a second PSSCH on a second carrier, and transmit corresponding first and second PSFCHs with HARQ-ACK information on a third carrier. In 1020, the UE determines first PSFCH resources available for transmission of the first PSFCH on slot k of the third carrier. In 1030, the UE determines second PSFCH resources available for transmission of the second PSFCH on slot k of the third carrier.

In response to a PSSCH reception, a UE can transmit HARQ-ACK information in a PSFCH. The PSFCH transmission can be in a same carrier as the PSSCH reception or in a different carrier, subject to a configuration and/or an indication in an SCI format scheduling the PSSCH reception. In order to improve a reception reliability of a PSFCH, the UE can transmit the PSFCH with repetitions.

A number of repetitions for a PSFCH transmission with HARQ-ACK information can be provided by a higher layer parameter or can be also indicated by an SCI format. The indication can be based on a separate field in the SCI format that indicates a number of repetitions for the PSFCH transmission or can be included in the configuration of PSFCH resources and a PSFCH resource can be indicated by the SCI format. In addition to parameters such as a PSFCH format, a starting symbol and a number of symbols, or a starting RB and a number of RBs, a PSFCH resource can also be associated with a number of repetitions for a PSFCH transmission. A 1-bit field in an SCI format, for example in SCI format 1-A that schedules PSSCH or in 2nd-stage-SCI on PSSCH, can indicate whether the PSFCH is with or without repetitions, and if the PSFCH transmission is with repetitions, the UE transmits the PSFCH with a number of repetitions provided by a higher layer parameter or by 2nd-stage-SCI on PSSCH. The UE can transmit PSFCH repetitions within a slot or over multiple slots, over consecutive or non-consecutive symbols, based on a configuration and/or an indication in an SCI format.

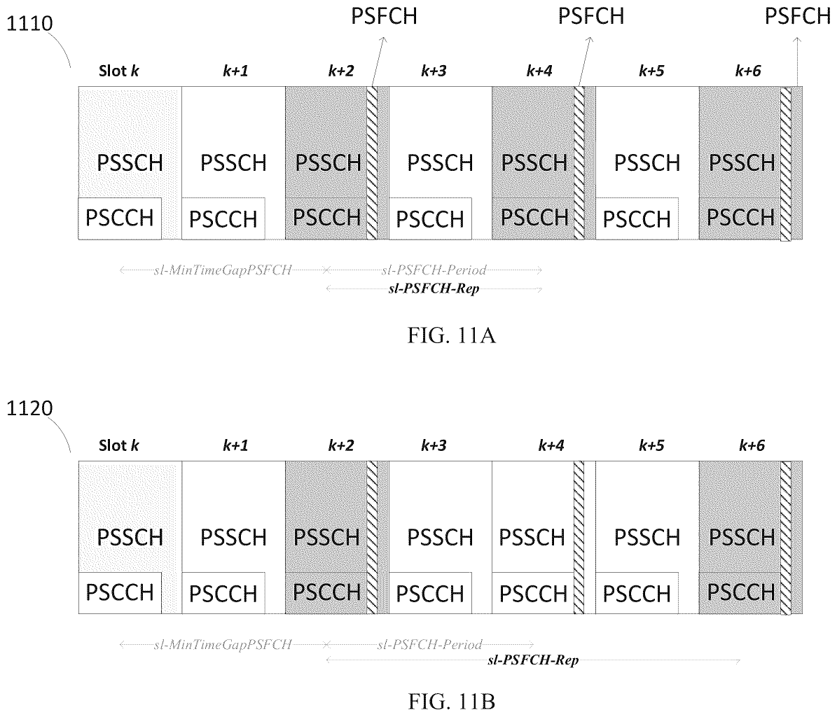

FIGS. 11A and 11B illustrates a diagram of example PSFCH transmissions with repetitions 1110 and 1120, respectively, according to embodiments of the present disclosure. For example, PSFCH transmissions with repetitions 1110 and 1120, respectively, can be utilized by any of the UEs 111-116 of FIG. 1, such as the UE 111A. This example is for illustration only and other embodiments can be used without departing from the scope of the present disclosure.

With reference to FIGS. 11A and 11B, examples of a PSFCH transmission with repetitions is shown wherein PSSCH receptions are on the same carrier of PSFCH transmissions. In a first example 1110, the UE is configured a higher layer parameter sl-PSFCH-Rep that indicates a number of slots in a resource pool for a period of PSFCH transmission occasion resources for repetitions. When the number is zero, PSFCH transmissions from the UE in the resource pool are without repetitions. A value of sl-PSFCH-Rep can be associated with a number of repetitions, and the UE can be provided a first sl-PSFCH-Rep associated with a first number of PSFCH repetitions and a second sl-PSFCH-Rep associated with a second number of PSFCH repetitions. Based on the configured or indicated number of PSFCH repetitions, the UE determines slots with PSFCH resources according to sl-PSFCH-Rep corresponding to the number of repetitions. The UE determines a first set of slots with PSFCH resources according to sl-PSFCH-Period, determines a second set of slots from the first set of slots with PSFCH resources for PSFCH repetitions according to sl-PSFCH-Rep, and transmits PSFCH repetitions in one or more slots from the second set of slots using a configured or indicated number of PSFCH repetitions. When the UE is not provided sl-PSFCH-Rep and is configured to transmit PSFCH with repetitions, the UE determines a set of slots with PSFCH resources according to sl-PSFCH-Period, and transmits PSFCH repetitions in one or more slots from the set of slots using a configured or indicated number of PSFCH repetitions.

In one example, the parameter sl-PSFCH-Rep can be set to a same value as the sl-PSFCH-Period, as in 1110 of FIG. 11A, and subsequent slots with PSFCH resources can be used for transmission of a PSFCH with repetitions. In one example, the parameter sl-PSFCH-Rep can be set to a value multiple of the value of sl-PSFCH-Period, as in 1120 of FIG. 11B, and not subsequent slots with PSFCH resources according to sl-PSFCH-Period can be used for transmission of a PSFCH with repetitions. The UE transmits a number of PSFCH repetitions, wherein the number of repetitions is provided by a higher layer parameter or by an SCI format scheduling a PSSCH reception associated with the PSFCH transmission with repetitions, in a slot with PSFCH resources according to sl-PSFCH-Period.

In one example, the parameter sl-PSFCH-Rep can be set to a value multiple of the value of sl-PSFCH-Period, as in 1120 of FIG. 11B, wherein sl-PSFCH-Rep is set to 4 slots and sl-PSFCH-Period is set to 2 slots, and not all subsequent slots with PSFCH resources according to sl-PSFCH-Period can be used for transmission of a PSFCH with repetitions.

Although FIGS. 11A and 11B and corresponding descriptions are for a same carrier for PSSCH receptions and PSFCH transmissions, they equally apply when a PSSCH receptions and corresponding PSFCH transmissions are on different carriers.

When a PSFCH is transmitted with repetitions, one or multiple repetitions can be transmitted in a same slot. The UE (e.g., the UE 111) can be configured with transmission of PSFCH repetitions and a slot can include one repetition, or can be configured with transmission of more than one repetition per slot.

The above flowchart illustrates an example method that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive first information related to a sidelink operation on multiple sidelink carriers, and
receive, via a sidelink control information (SCI) format, second information related to a first carrier from the multiple sidelink carriers for transmission of a physical sidelink feedback channel (PSFCH), wherein:
the PSFCH includes hybrid automatic repeat request acknowledgement (HARQ-ACK) information corresponding to reception of a physical sidelink shared channel (PSSCH), and
reception of a physical sidelink control channel (PSCCH) associated with the PSSCH is on a second carrier; and
a processor operably coupled to the transceiver, the processor configured to determine a resource for transmission of the PSFCH on the first carrier from a sidelink resource pool of PSFCH resources associated with the first carrier,
wherein the transceiver is further configured to transmit the PSFCH on the first carrier using the resource.

2. The UE of claim 1, wherein:
the PSCCH includes the SCI format that schedules the reception of the PSSCH, and
reception of the PSSCH is on the first carrier.

3. The UE of claim 1, wherein:
the PSSCH includes the SCI format, and
reception of the PSSCH is on the second carrier or in a third carrier.

4. The UE of claim 1, wherein:
the transceiver is further configured to receive a mapping that associates a first set of carriers for PSSCH receptions with a second set of carriers for corresponding PSFCH transmissions, and
the mapping is a one-to-one mapping or a many-to-one mapping.

5. The UE of claim 1, wherein:
the SCI format schedules receptions of a number of PSSCHs on corresponding carriers from the multiple sidelink carriers,
the SCI format indicates the first carrier for transmissions of PSFCHs associated with the number of PSSCHs, and
the processor is further configured to determine PSFCH resources for transmissions of PSFCHs from the sidelink resource pool of PSFCH resources associated with the first carrier.

6. The UE of claim 1, wherein:
the SCI format schedules a number of receptions of the PSSCH on corresponding carriers from the multiple sidelink carriers,
the SCI format indicates the first carrier for transmissions of PSFCHs associated with the number of receptions of the PSSCH, and
the transceiver is further configured to transmit the PSFCH with corresponding negative acknowledgment information.

7. The UE of claim 1, wherein
reception of the PSCCH including the SCI format is on a primary carrier,
the SCI format schedules receptions of a number of PSSCHs on corresponding carriers from the multiple sidelink carriers, and
the primary carrier is one of the corresponding carriers.

8. The UE of claim 1, wherein:
the transceiver is further configured to receive a set of one or more numbers for repetitions of the PSFCH, and
the processor is further configured to determine:
a number of repetitions, from the set of one or more numbers for repetitions, and
PSFCH resources for the transmission of the PSFCH with repetitions on the first carrier based on a higher layer parameter.

9. The UE of claim 8, wherein, when the set is more than one, the number of repetitions is based on a value of a field in the SCI format.

10. The UE of claim 8, wherein:
the number of repetitions includes:
a first number of repetitions for a transmission of a first PSFCH, and
a second number of repetitions for a transmission of a second PSFCH;
the PSFCH resources include:
first resources in a time slot for the transmission of the first PSFCH, and
second resources in the time slot for the transmission of the second PSFCH; and
the transceiver is further configured to transmit the first PSFCH with the first number of repetitions and the second PSFCH with the second number of repetitions in the first and second resources, respectively, in the time slot.

11. A method performed by a user equipment (UE) in a wireless communication system, the method comprising:
receiving first information related to a sidelink operation on multiple sidelink carriers;
receiving, via a sidelink control information (SCI) format, second information related to a first carrier from the multiple sidelink carriers for transmission of a physical sidelink feedback channel (PSFCH), wherein:
the PSFCH includes hybrid automatic repeat request acknowledgement (HARQ-ACK) information corresponding to reception of a physical sidelink shared channel (PSSCH), and
reception of a physical sidelink control channel (PSCCH) associated with the PSSCH is on a second carrier;
determining a resource for transmission of the PSFCH on the first carrier from a sidelink resource pool of PSFCH resources associated with the first carrier; and
transmitting the PSFCH on the first carrier using the resource.

12. The method of claim 11, wherein:
the PSCCH includes the SCI format that schedules the reception of the PSSCH, and
reception of the PSSCH is on the first carrier.

13. The method of claim 11, wherein:
the PSSCH includes the SCI format, and
reception of the PSSCH is on the second carrier or in a third carrier.

14. The method of claim 11, further comprising:
receiving a mapping that associates a first set of carriers for PSSCH receptions with a second set of carriers for corresponding PSFCH transmissions,
wherein the mapping is a one-to-one mapping or a many-to-one mapping.

15. The method of claim 11, wherein:
the SCI format schedules receptions of a number of PSSCHs on corresponding carriers from the multiple sidelink carriers,
the SCI format indicates the first carrier for transmissions of PSFCHs associated with the number of PSSCHs, and
the method further comprises determining PSFCH resources for transmissions of PSFCHs from the sidelink resource pool of PSFCH resources associated with the first carrier.

16. The method of claim 11, wherein:
the SCI format schedules a number of receptions of the PSSCH on corresponding carriers from the multiple sidelink carriers,
the SCI format indicates the first carrier for transmissions of PSFCHs associated with the number of receptions of the PSSCH, and
the method further comprises transmitting the PSFCH with corresponding negative acknowledgment information.

17. The method of claim 11, wherein
reception of the PSCCH including the SCI format is on a primary carrier,
the SCI format schedules receptions of a number of PSSCHs on corresponding carriers from the multiple sidelink carriers, and
the primary carrier is one of the corresponding carriers.

18. The method of claim 11, further comprising:
receiving a set of one or more numbers for repetitions of the PSFCH; and
determining:
a number of repetitions, from the set of one or more numbers for repetitions, and
PSFCH resources for the transmission of the PSFCH with repetitions on the first carrier based on a higher layer parameter.

19. The method of claim 18, wherein, when the set is more than one, the number of repetitions is based on a value of a field in the SCI format.

20. The method of claim 18, wherein:
the number of repetitions includes:
a first number of repetitions for a transmission of a first PSFCH, and
a second number of repetitions for a transmission of a second PSFCH;
the PSFCH resources include:
first resources in a time slot for the transmission of the first PSFCH, and
second resources in the time slot for the transmission of the second PSFCH; and
the method further comprises transmitting the first PSFCH with the first number of repetitions and the second PSFCH with the second number of repetitions in the first and second resources, respectively, in the time slot.
